(19) United States
(12) Patent Application Publication
(10) Pub. No.: US 2026/0289856 A1
(43) Pub. Date: Sep. 24, 2026

(54) SYSTEM

(71) Applicant: SoftBank Group Corp., Tokyo (JP)

(72) Inventor: Ikki HIRABAYASHI, Tokyo (JP)

(73) Assignee: SoftBank Group Corp., Tokyo (JP)

(21) Appl. No.: 19/565,624

(22) Filed: Mar. 13, 2026

(30) Foreign Application Priority Data
Mar. 19, 2025 (JP) 2025-045153

(51) Int. Cl. G06T 11/60; G06N 20/00; H04L 51/02

(52) U.S. Cl. CPC G06T 11/60; G06N 20/00; H04L 51/02

(57) ABSTRACT

A system includes a processor that is configured to receive, from a user, a prompt that instructs a generative artificial intelligence to describe a preferred clothing style of the user, cooperate with the generative artificial intelligence to analyze the prompt and to generate an individual fashion design based on preferences of the user indicated in the prompt, and recognize an emotion of the user and adjust the fashion design based on the recognized emotion of the user.

### CROSS-REFERENCE TO RELATED APPLICATION

This application is based on and claims priority under 35 USC 119 from Japanese Patent Application No. 2025-045153 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional fashion recommendation and design systems primarily rely on static user preferences such as color, material, and style, which are typically collected through fixed-choice interfaces or simple text input. These systems generally generate fashion designs or recommendations solely based on such explicit preferences and do not adequately account for dynamic emotional states of the user at the time of design generation. As a result, there is a mismatch between the user's current emotional condition and the proposed fashion design, leading to reduced satisfaction, lower engagement, and limited personalization.

Furthermore, existing systems often separate the processes of design generation, user feedback collection, and virtual try-on. This fragmentation requires the user to use different applications or interfaces, increases operational complexity, and prevents seamless iterative refinement of a design. In particular, there is an absence of an integrated mechanism that: (i) accepts a natural-language prompt from the user to guide a generative artificial intelligence, (ii) automatically recognizes the user's emotion, (iii) adjusts the design according to both preferences and emotional state, (iv) stores the resulting design, and (v) enables virtual try-on and interactive feedback through smart devices.

Accordingly, there is a need for a system capable of generating and iteratively refining individual fashion designs by combining user preferences and recognized emotional states, and of providing a unified experience from initial prompt entry to virtual try-on and feedback-based adjustment, thereby improving personalization, user satisfaction, and usability.

### SUMMARY

In order to solve the above-described problems, an aspect of the present invention provides a system comprising a processor, wherein the processor is configured to receive, from a user, a prompt that instructs a generative artificial intelligence to describe a preferred clothing style of the user, cooperate with the generative artificial intelligence to analyze the prompt and to generate an individual fashion design based on preferences of the user indicated in the prompt, and recognize an emotion of the user and adjust the fashion design based on the recognized emotion of the user. By combining explicit preference information with emotional information, the system can generate fashion designs that are more closely aligned with the user's situational needs and psychological state.

In another aspect, the processor is configured to store, in a database, the fashion design generated based on the preferences and the emotion of the user. By storing such designs in association with the user, the system can build a history of emotionally contextualized fashion designs, thereby enabling future retrieval, reuse, analysis of preference trends, and further personalization over time.

In a further aspect, the processor is configured to present, to the user, the fashion design generated based on the preferences and the emotion of the user, adjust the fashion design based on feedback from the user, and provide an application that enables virtual try-on of the fashion design through a smart device. Through this integrated application, the user can visually confirm the design on a virtual representation, provide iterative feedback, and cause the system to refine the fashion design accordingly. Consequently, the invention realizes a closed-loop fashion design environment that unifies preference input, emotional recognition, AI-based design generation, storage, feedback-based adjustment, and virtual try-on, thereby effectively addressing the above-mentioned problems.

The term “system” refers to a combination of hardware and software components, including at least one processor and associated memory and interfaces, that cooperatively perform the functions described in the claims.

The term “processor” refers to one or more processing units, such as a central processing unit (CPU), graphics processing unit (GPU), digital signal processor (DSP), or specialized hardware, that execute instructions to perform operations specified by the system.

The term “user” refers to a human individual who interacts with the system by providing input, reviewing output, and optionally giving feedback regarding fashion designs.

The term “prompt” refers to a natural-language or semi-structured textual input provided by the user to indicate or instruct desired clothing styles, preferences, or conditions to a generative artificial intelligence.

The term “generative artificial intelligence” refers to a machine learning-based model or set of models configured to generate new content, including fashion design concepts or descriptions, in response to input such as the prompt, rather than merely retrieving or ranking existing content.

The term “clothing style” refers to characteristics of garments, including but not limited to type of garment, silhouette, fit, color, material, pattern, decorative elements, and overall aesthetic impression.

The term “individual fashion design” refers to a specific garment or outfit concept generated for a particular user, which is based on that user's preferences and optionally on that user's emotional state, and which may include structured attributes and descriptive information.

The term “preference” or “preferences of the user” refers to explicit or implicit likes, dislikes, or requirements of the user regarding clothing, including attributes such as color, material, fit, style, occasion, and other fashion-related characteristics.

The term “emotion” or “emotion of the user” refers to a psychological or affective state of the user, such as happiness, sadness, excitement, calmness, stress, or other emotional conditions, which can be recognized or inferred by the system and used to influence fashion design.

The term “recognize an emotion” refers to detecting, classifying, or estimating an emotional state of the user by analyzing input signals, which may include textual expressions, voice, images, physiological data, interaction behavior, or combinations thereof.

The term “adjust the fashion design” refers to modifying one or more attributes of an individual fashion design, such as color, silhouette, material, or decorative detail, in response to recognized emotions, user feedback, or other contextual information, while maintaining consistency with the user's preferences.

The term “database” refers to any structured data storage system, including relational, NoSQL, or other data repositories, used to store fashion designs, user preferences, emotional states, feedback information, and related data for retrieval and processing by the processor.

The term “store” refers to recording or saving data in a non-transitory storage medium, such as a database, memory, or file system, so that the data can be subsequently accessed, retrieved, or processed by the system.

The term “present to the user” refers to outputting information about a fashion design to the user in a perceivable form, including displaying text, images, 3D models, or interactive interfaces on a screen of a terminal or smart device.

The term “feedback from the user” refers to responses, evaluations, modifications, or other inputs provided by the user regarding a presented fashion design, including approvals, rejections, parameter changes, ratings, comments, or selections.

The term “smart device” refers to an electronic device with computational capability, connectivity, and a user interface, such as a smartphone, tablet, smart glasses, or other wearable device, capable of running applications and supporting virtual try-on functions.

The term “virtual try-on” refers to a process in which a user views a simulated appearance of a fashion design on a digital representation of the user, such as an avatar or an augmented reality overlay, without physically wearing the actual garment.

The term “application” refers to software executed on a smart device or other terminal that provides functions of presenting fashion designs, receiving user feedback, and enabling virtual try-on in cooperation with the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

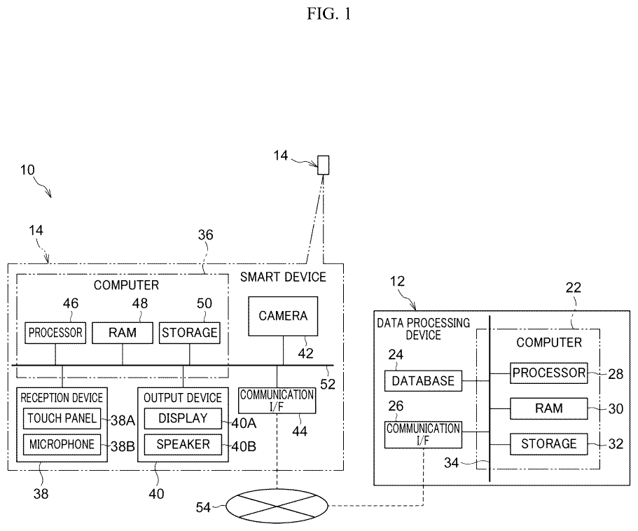

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

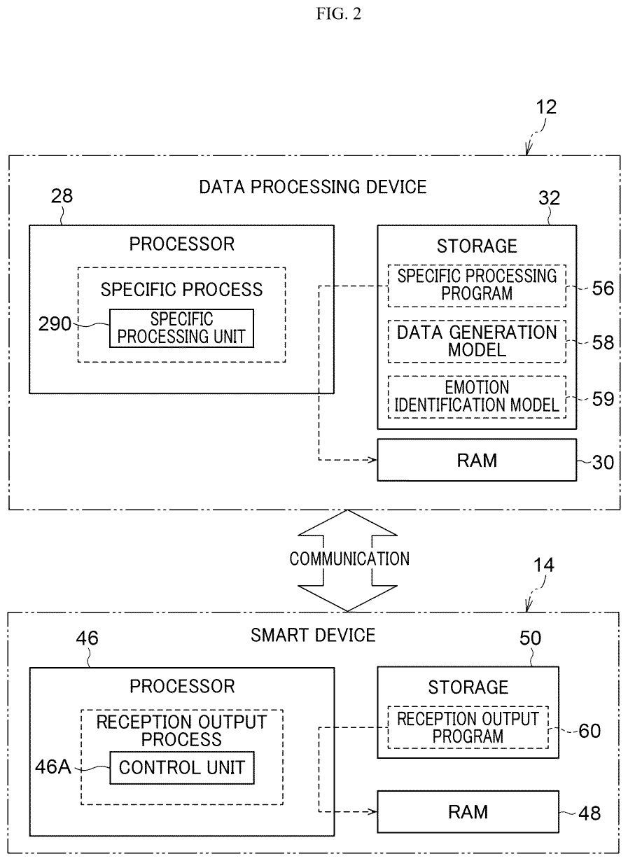

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented fashion recommendation systems typically employ fixed rule-based engines or simple attribute matching to generate suggestions. Such systems generally require the user to manually select predefined options from hierarchical menus or checkboxes, and then map the selected options directly to static templates. As a result, these systems are not well-suited to processing rich natural-language input, cannot flexibly reflect subtle user preferences expressed in free text, and often output generic proposals that fail to satisfy the user. Furthermore, known systems usually treat user feedback as a one-time rating or selection, rather than as an iterative natural-language refinement that can be computationally integrated into subsequent design generation.

From a computer-technology perspective, existing systems do not provide an integrated processing pipeline that transforms unstructured natural-language descriptions and feedback into normalized, machine-usable attribute representations, dynamically configures prompt sentences for a generative AI model, and iteratively updates those representations and prompt sentences based on user interaction and emotional state. The absence of such a pipeline leads to inefficient utilization of computational resources of natural-language processing components and generative AI models, as the models are often invoked with suboptimal or poorly structured prompts. This reduces the quality, stability, and controllability of generated results, and requires additional manual tuning by human operators.

Moreover, conventional systems typically lack a mechanism to infer a user's emotional state and to adjust internal representations or prompts in response to the inferred emotional state. In particular, the computing components do not adaptively modify attribute weights, prompt wording, or generation parameters based on whether the user is, for example, frustrated, excited, or indifferent. As a consequence, the system cannot improve interaction efficiency or output relevance at the system level and fails to optimize the operation of the underlying computational resources.

Accordingly, there is a need for a computer-implemented technique that improves the processing of natural-language input and feedback, enhances the construction and updating of prompt sentences for a generative AI model, and integrates emotion estimation into the control loop, thereby improving the functioning of the overall data processing system. The challenge is to provide a server-side architecture and processing sequence that (i) programmatically converts unstructured text into normalized attribute information; (ii) automatically generates and iteratively updates prompt sentences for a generative AI model based on both user preferences and feedback; (iii) coordinates the interaction between a terminal, a server, and a generative AI model; and (iv) dynamically adjusts the internal data and prompts in accordance with an estimated emotional state of the user, to thereby improve the efficiency, adaptability, and accuracy of the computer system as a whole.

The specific processing by the specific processing unit 290 of the data processing device 12 in Example 1 is realized by the following means.

The present invention provides a server comprising a processor and a memory storing instructions that, when executed by the processor, cause the server to receive, from a terminal, a natural-language description of preferred clothing or styles input by a user through an information input interface of the terminal; analyze the received natural-language description by using a natural-language processing algorithm to extract keywords indicating attributes including at least a color, a material, a shape, and a style; convert the extracted keywords into normalized attribute information based on a higher-level attribute schema maintained in the memory; generate, based on the normalized attribute information, a prompt sentence by embedding the normalized attribute information into a prompt template configured as an input format for a generative AI model; transmit the generated prompt sentence to the generative AI model via a communication interface so as to cause the generative AI model to generate proposal information for clothing or styles corresponding to the normalized attribute information; receive, from the generative AI model, the proposal information and convert the proposal information into display data and transmit the display data to the terminal for presentation to the user; receive, from the terminal, feedback expressed in natural language with respect to the proposal information; analyze the feedback using the natural-language processing algorithm to extract keywords indicating a design change request; update the normalized attribute information in accordance with the design change request; reconstruct, based on the updated normalized attribute information, the prompt sentence and retransmit the reconstructed prompt sentence to the generative AI model so as to cause the generative AI model to iteratively generate updated proposal information reflecting the feedback; estimate, based on at least one of the natural-language description, the feedback, and interaction history, an emotional state of the user using an emotion estimation algorithm executed by the processor; and adjust at least one of the normalized attribute information and the prompt sentence in accordance with the estimated emotional state so that the generative AI model generates proposal information that reflects both the user's stated preferences and the emotional state of the user. This enables the computer system to transform unstructured user input into structured attribute data, construct and iteratively refine prompt sentences for a generative AI model under programmatic control, and dynamically adapt internal representations and generation behavior based on estimated user emotion, thereby improving the technical performance, controllability, and output relevance of the underlying data processing architecture.

The term “system” refers to a combination of at least one server, at least one terminal, and at least one generative AI model, together with communication paths and software components that cooperate to perform the claimed functions.

The term “server” refers to an electronic data processing apparatus including at least one processor, a memory, and a communication interface, configured to execute programs that perform natural-language analysis, attribute normalization, prompt sentence generation, interaction with a generative AI model, and management of proposal information.

The term “terminal” refers to an electronic apparatus operated by a user, including at least one input device and at least one display device, and configured to transmit user input to the server and to present proposal information and interfaces for feedback to the user.

The term “processor” refers to a hardware computation unit, such as a central processing unit or a specialized processing circuit, capable of executing instructions to perform data processing operations specified in the claims.

The term “memory” refers to a non-transitory computer-readable storage medium, such as a semiconductor memory device, a magnetic storage device, or an optical storage device, configured to store instructions and data for use by the processor.

The term “communication interface” refers to a hardware and software combination that enables data exchange between the server, the terminal, and the generative AI model over a communication network.

The term “natural-language description” refers to text data expressed in a human language, input by the user in free form, and including information about preferred clothing or styles without being restricted to predefined codes or menu selections.

The term “information input interface” refers to a user interface component on the terminal that allows the user to enter the natural-language description and feedback, such as a text box, a form, or a similar input mechanism.

The term “proposal information” refers to data generated by the generative AI model that represents a proposed clothing or style design, and may include at least one of a textual description, structured attributes, and image data.

The term “generative AI model” refers to a machine learning model configured to generate text, images, or other content in response to an input prompt sentence, based on parameters learned from training data.

The term “prompt sentence” refers to text data provided as input to the generative AI model, the text data being constructed to encode normalized attribute information, user preferences, and optionally further instructions to control the generation behavior.

The term “prompt template” refers to a predefined text pattern including placeholders for attribute information, which is processed by the server to construct the prompt sentence by inserting normalized attribute values.

The term “natural-language processing algorithm” refers to a computational procedure implemented in software that analyzes natural-language text, including at least one of tokenization, part-of-speech tagging, keyword extraction, and entity recognition.

The term “keyword” refers to a word or phrase extracted from a natural-language text that is determined to represent an attribute relevant to clothing or style, such as a color, a material, a shape, or a style descriptor.

The term “attribute” refers to a property of clothing or styles, including at least a color, a material, a shape, a size, a style, or a design detail, that can be used to characterize or generate a fashion design.

The term “normalized attribute information” refers to a structured representation of attributes obtained by mapping extracted keywords to standardized attribute values defined in a higher-level attribute schema.

The term “higher-level attribute schema” refers to a set of definitions and relationships that organizes attributes, such as colors, materials, shapes, and styles, into standardized categories and identifiers used for normalization and processing.

The term “design change request” refers to content within the user's feedback that indicates a modification to be applied to an existing design proposal, such as changing length, color, neckline, or decorative elements.

The term “feedback” refers to natural-language text or other user input specifying an evaluation, preference adjustment, or modification request regarding proposal information previously presented to the user.

The term “display data” refers to data formatted for presentation on the terminal's display device, including textual elements, graphical elements, and references to image resources derived from the proposal information.

The term “interaction history” refers to stored records of previous exchanges between the user and the system, including natural-language descriptions, feedback, prompt sentences, proposal information, and timestamps.

The term “emotion estimation algorithm” refers to a computational procedure that analyzes at least one of the natural-language description, the feedback, and the interaction history to infer an emotional state of the user, such as satisfaction, dissatisfaction, or enthusiasm.

The term “emotional state” refers to a condition associated with the user's affect or mood, inferred by the emotion estimation algorithm, and used to adjust internal processing or prompt generation.

The term “storage device” refers to a physical data storage component, such as a disk device, a solid-state drive, or a memory module, used to persistently store data sets associated with identifiers.

The term “data set” refers to a collection of related data elements, including at least one of the natural-language description, the prompt sentence, the normalized attribute information, the proposal information, the feedback, and associated identifiers.

The term “identifier” refers to a data item, such as a numeric or alphanumeric value, that uniquely associates a data set with a particular user, request, or proposal within the system.

The term “virtual try-on function” refers to a software function that causes clothing or style representations to be visually superimposed on body information of the user, so that the user can view an approximation of wearing the proposed clothing.

The term “body information” refers to data representing physical characteristics of the user, such as images, body measurements, or a three-dimensional body model, used for generating or displaying virtual try-on views.

The term “virtual-reality technology” refers to a computer-generated simulation technique that presents an immersive environment, in which virtual representations of clothing or styles can be rendered around a user representation.

The term “augmented-reality technology” refers to a technique by which virtual objects, including representations of clothing or styles, are superimposed on a real-world scene captured by a camera or displayed on a screen.

In one embodiment, the system includes at least one server, at least one terminal, and at least one generative AI model interconnected via a communication network such as the Internet. The server includes at least one processor, a main memory, a non-transitory storage device, and a network interface. The terminal includes at least one processor, a memory, an input device such as a touch panel or keyboard, and a display device such as a liquid crystal display or organic light-emitting display. The generative AI model executes on a computing platform that includes at least one graphics processing unit or tensor processing unit and a main memory for storing learned parameters.

The terminal executes an application implemented, for example, as a web application running in a web browser or as a native mobile application. The terminal presents a text input field and control elements for sending user input. The user operates the terminal and inputs a natural-language description of preferred clothing or styles, such as preferred colors, materials, shapes, and stylistic attributes. The user may input, for example, the text “I like red silk dresses with an elegant and sophisticated design suitable for evening parties.” The terminal stores the input text in a buffer in memory and prepares a structured message including at least a user identifier and the text. The terminal transmits the message to the server through the network interface using a transport protocol such as HTTPS.

The server receives the message from the terminal via the network interface and stores the received text and metadata in a storage device such as a magnetic disk or solid-state drive. The server uses a data structure such as a relational table or a document-oriented record to associate the natural-language description with the user identifier and a request identifier. The server then performs natural-language analysis using an executable module that implements a natural-language processing algorithm. The server may use, for example, a statistical language model or a transformer-based encoder model that performs tokenization, part-of-speech tagging, and entity extraction.

The server converts the natural-language description into tokens, maps each token to an integer index based on a vocabulary, and stores the indices in a sequence data structure in memory. The server applies a multi-layer neural network, such as a transformer encoder with multiple self-attention layers, to the token sequence to compute contextual embeddings. Each layer performs matrix multiplications and non-linear activation functions on the embeddings, where the processor executes vectorized instructions to improve throughput. The server derives attention weights that indicate the importance of each token in context, and uses those weights to identify candidate keywords corresponding to attributes such as colors, materials, shapes, and style descriptors. For example, the server extracts keywords including “red,” “silk,” “dress,” “elegant,” and “sophisticated.”

The server normalizes the extracted keywords by referencing a higher-level attribute schema stored in the storage device. The server uses one or more lookup tables that map synonyms and variant expressions to canonical attribute identifiers. For instance, the server maps “red” and “crimson” to a canonical color identifier, maps “silk” to a canonical material identifier, and maps “elegant” and “refined” to canonical style identifiers. The server constructs a normalized attribute object, for example as a structured record in memory, that includes fields for at least color, material, garment type, and style categories. By storing and manipulating this normalized attribute information, the server reduces ambiguity and improves consistency across multiple user requests.

The server generates a prompt sentence for a generative AI model based on the normalized attribute information. The server stores one or more prompt templates in the storage device as text patterns with placeholders for attributes. The server selects a template, retrieves the canonical attribute labels from the schema, and replaces placeholders in the template with the corresponding labels. The server thus constructs a text string that serves as a prompt sentence. For example, the server may construct the prompt sentence “Please propose a red silk evening dress with an elegant and sophisticated design suitable for formal parties. Include details about length, neckline, silhouette, and decorative elements.” The server writes the prompt sentence to memory and associates it with the request identifier.

The server transmits the prompt sentence to the generative AI model using an application programming interface. The generative AI model is implemented as a deep neural network, for example an autoregressive transformer decoder model with multiple attention layers and learned parameters stored in a parameter matrix set. The generative AI model receives the prompt sentence as input, encodes the text into token indices, and performs sequential prediction of output tokens or image latent codes based on the learned parameters. During training, the generative AI model minimizes an objective function, such as cross-entropy loss for next-token prediction, using an optimization method such as stochastic gradient descent with backpropagation. During inference in the present embodiment, the generative AI model applies the learned parameters without further parameter updates.

The generative AI model outputs proposal information that includes at least a text description of clothing or styles, and optionally image data representing visual designs. The server receives the output through the network interface and parses the response structure. The server may further process the text output, for example by segmenting it into fields such as length, neckline, silhouette, and decoration, using rule-based parsing or a second natural-language processing module. The server may also perform image post-processing, such as resizing or re-encoding images to a suitable resolution and format for the terminal display. The server constructs display data that includes textual content and references to image resources, and stores this display data in association with the user identifier and the prompt sentence.

The terminal receives the display data from the server and renders the proposal information. The terminal draws text on the display device and decodes and renders images if present. The user visually inspects the proposed clothing or style and decides whether to accept it or refine it. The user then operates the input interface again to provide natural-language feedback. The user may input, for example, the text “Make the dress slightly shorter, add a V-neckline, and avoid sequins.” The terminal transmits this feedback text to the server in a structured message similarly to the initial description.

The server receives the feedback and analyzes it using the same or a related natural-language processing algorithm. The server identifies modification-oriented keywords, such as “shorter,” “V-neckline,” and “avoid sequins,” and maps them to specific attribute changes in the normalized attribute information. The server updates the normalized attribute object in memory by changing the length parameter from “floor-length” to “knee-length,” by setting the neckline parameter to “V-neck,” and by adding a constraint that disallows a particular decoration category. The server then reconstructs a new prompt sentence reflecting both the original preference and the new constraints. For example, the server may construct the prompt sentence “Based on the previous red silk evening dress design, please propose a shorter red silk dress with a V-neckline and no sequins, keeping the overall style elegant and sophisticated.” The server sends this new prompt sentence to the generative AI model, which generates updated proposal information.

The server iteratively performs this update and reconstruction of prompt sentences as long as the user provides feedback. By representing user preferences and feedback as structured, normalized attributes and by feeding these attributes into prompt templates, the server reduces the need for manual prompt engineering and ensures that the generative AI model receives consistently structured inputs. This structure improves the stability and predictability of the generative AI model's outputs and reduces the computational overhead of trial-and-error prompt tuning that would otherwise be required.

In another embodiment, the server estimates an emotional state of the user and uses the estimated emotional state to adjust the normalized attribute information or the prompt sentence. The server obtains data for emotion estimation from at least one of the natural-language descriptions, the feedback texts, interaction timing information, and user behavior logs. The server processes the texts using a classification model, such as a neural network trained on labeled emotional data, that maps input embeddings to probability distributions over emotion categories. The server may use, for example, a transformer encoder followed by a fully connected layer that outputs scores for categories such as “satisfied,” “frustrated,” or “indifferent.” The server calculates an emotional state label based on the maximum probability or on a threshold rule.

The server adjusts the prompt sentence or the normalized attribute information using rules or learned mappings based on the emotional state. When the server determines that the user is “frustrated,” the server may make the prompt sentence more specific by narrowing attribute ranges or by instructing the generative AI model to generate multiple alternatives. When the server determines that the user is “satisfied,” the server may generate prompt sentences that make smaller adjustments from the previous proposal, thereby conserving computational resources. This emotion-based adjustment reduces unnecessary calls to the generative AI model and focuses the computation on promising design directions. As a result, the number of iterations required to reach a satisfactory proposal decreases, which improves processing speed and reduces network and compute load.

The server stores, in the storage device, data sets that include the natural-language descriptions, prompt sentences, normalized attribute information, proposal information, feedback, emotional state labels, and identifiers. The server uses these data sets to improve the efficiency of future sessions by reusing prior attribute configurations or by initializing the generative AI model with context derived from previous interactions. The server may also use the stored data for offline training or fine-tuning of the natural-language processing modules and emotion estimation models, thereby improving classification accuracy and keyword extraction over time.

In one technical variation, the generative AI model generates image data of clothing or styles in a compressed latent space using a latent diffusion process. The generative AI model receives an encoded prompt sentence, embeds it in a continuous space, and uses it as a conditioning signal in a diffusion model that iteratively denoises a latent representation into a coherent image. The server controls the number of diffusion steps and the guidance scale parameter for the latent diffusion model based on the normalized attribute information and emotional state, thereby controlling the balance between adherence to the prompt and diversity of generated images. This control enables the server to use fewer diffusion steps in early exploratory stages and more steps when fine details are required, improving overall computational efficiency.

In another technical variation, the terminal supports a virtual try-on function. The terminal acquires body information of the user, such as an image captured by a camera or a three-dimensional body model stored in memory. The terminal receives from the server either generated images with transparent backgrounds or parameterized garment shapes. The terminal executes a rendering pipeline that deforms the garment representation to fit the body model using geometric transformation algorithms and overlays the garment representation on the user's body image in real time. The terminal thus produces a composite image that shows the user virtually wearing the generated clothing. This operation requires the terminal to apply graphics processing operations, such as mesh deformation, alpha blending, and real-time shading, in addition to simple display.

The above embodiments provide technical effects that go beyond the mere automation of manual design selection. The server does not simply replace a human designer; instead, the server transforms unstructured text into structured, normalized attributes using a non-trivial combination of neural language models and schema-based normalization, dynamically generates and refines prompt sentences for a generative AI model, and manages iterative control loops that incorporate emotion estimation. This processing improves the functioning of the computer system itself by reducing redundant computation, lowering communication overhead between the server and the generative AI model, and improving the quality and consistency of generated proposals. For example, because the server maintains normalized attribute information across iterations, the server avoids re-parsing and re-interpreting previously resolved constraints, which reduces processing latency and increases throughput when handling many concurrent users.

In still another embodiment, the server and the generative AI model are deployed on separate physical machines. The server aggregates multiple prompt sentences from different users and schedules batched inference requests to the generative AI model. The server thus reduces the number of network round trips and exploits vectorized computations on the generative AI platform. The batched processing improves utilization of hardware accelerators and reduces average response time per request. The server may apply a queue management algorithm to group prompt sentences with similar attribute structures, thereby enabling shared attention computation for parts of the input, further optimizing computational efficiency.

Alternative embodiments may use different natural-language processing algorithms, such as rule-based keyword extraction combined with shallow classifiers, or different generative AI architectures, such as encoder-decoder models that generate structured attribute sets instead of free-form text. The server may generate prompt sentences in different languages or formats, and may include additional control codes that instruct the generative AI model to obey specific design constraints. The terminal may be implemented as a head-mounted display device, and the virtual try-on function may be executed in a fully immersive environment. In all embodiments, the server, the terminal, and the generative AI model cooperate via defined data structures and control flows to implement the claimed system functions while improving computational efficiency, precision in attribute interpretation, and relevance of generated proposals.

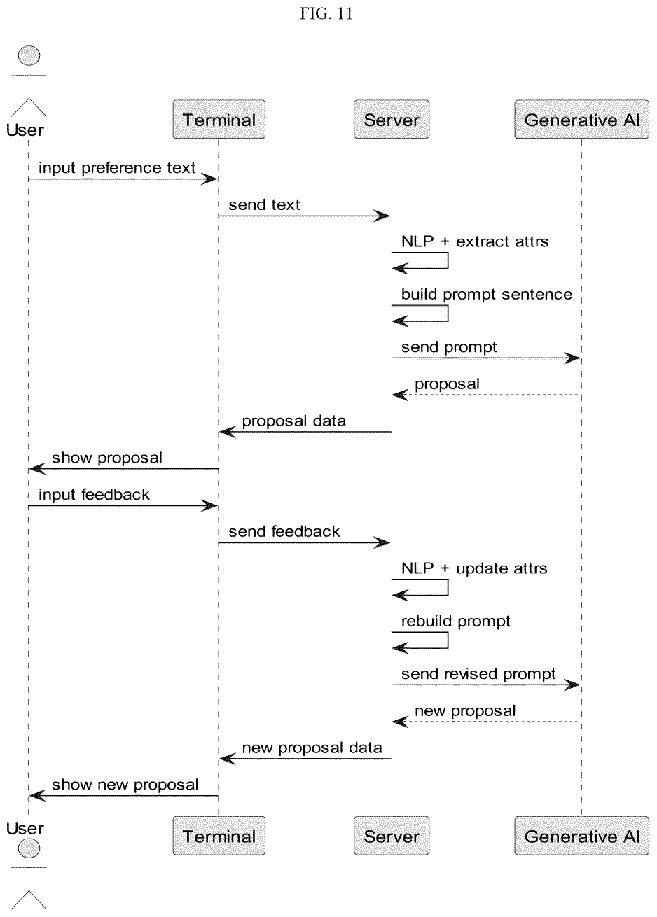

The following describes the processing flow using FIG. 11.
Step 1:

The terminal displays a text input interface on a display device and initializes an empty text buffer in a memory.

The user operates the terminal and inputs a natural-language description of preferred clothing or styles into the text input interface.

The terminal receives, as input, the text characters entered by the user and stores the characters sequentially into the text buffer, updating a cursor position and counting the number of characters.

The terminal validates the input by checking that the number of characters is within a predetermined range and that the encoding is valid.

The terminal, in response to an operation such as a “Submit” button press by the user, constructs as output a request object that includes at least a user identifier and the natural-language description, and the terminal transmits the request object to the server via a network interface using a communication protocol.
Step 2:

The server receives, as input, the request object transmitted from the terminal, via a network interface.

The server parses the request object to extract fields including the user identifier and the natural-language description, and the server assigns a request identifier.

The server stores the natural-language description, together with the user identifier and the request identifier, in a storage device using a predefined data structure such as a record in a relational table.

The server outputs a stored record that associates the natural-language description with the user identifier and the request identifier, enabling subsequent retrieval for processing.
Step 3:

The server retrieves, as input, the natural-language description associated with the request identifier from the storage device.

The server tokenizes the description by splitting the text into tokens based on whitespace and punctuation rules, and the server maps each token to an integer index using a vocabulary table stored in memory.

The server constructs, as an intermediate output, a sequence of token indices representing the natural-language description, and the server stores this sequence in a sequence data structure in memory for further processing.
Step 4:

The server receives, as input, the sequence of token indices, and the server applies a natural-language processing algorithm implemented as a neural network model stored in memory.

The server performs matrix multiplications and activation functions layer by layer to compute contextual embeddings for each token, using the processor to execute vectorized operations for efficiency.

The server calculates attention weights that indicate relevance of tokens in context, and the server uses these weights along with pattern rules to identify tokens corresponding to attributes such as colors, materials, garment types, and style descriptors.

The server generates, as output, a keyword list such as [“red”, “silk”, “dress”, “elegant”, “sophisticated”], and the server stores this keyword list in memory linked to the request identifier.
Step 5:

The server receives, as input, the keyword list and a higher-level attribute schema stored in the storage device.

The server iterates over each keyword and performs lookups in attribute tables that map textual expressions to canonical attribute identifiers, such as color identifiers, material identifiers, garment identifiers, and style identifiers.

The server resolves synonyms and variant expressions to standardized forms and filters out irrelevant or ambiguous tokens using rule-based logic.

The server constructs, as output, normalized attribute information represented as a structured data object with fields for at least color, material, garment type, and style categories, and the server stores this object in memory.
Step 6:

The server receives, as input, the normalized attribute information and one or more prompt templates stored as text patterns with placeholders.

The server selects an appropriate prompt template based on the garment type or context, and the server retrieves textual labels corresponding to the attribute identifiers from the attribute schema.

The server replaces placeholders in the template with the textual labels, concatenating words and phrases with appropriate grammatical connectors to form a coherent prompt sentence.

The server generates, as output, a prompt sentence such as “Please propose a red silk evening dress with an elegant and sophisticated design suitable for formal parties. Include details about length, neckline, silhouette, and decorative elements.” and stores this prompt sentence in memory associated with the request identifier.
Step 7:

The server receives, as input, the prompt sentence and configuration parameters for a generative AI model, such as model name and generation options.

The server constructs an API request message that includes the prompt sentence and the configuration parameters, and the server sends the message to the generative AI model via a communication interface.

The generative AI model processes the prompt sentence using a generative neural network and returns, as output to the server, proposal information including at least a text description of a proposed clothing or style design, and optionally image data or references to generated images.

The server receives the proposal information through the network interface and stores the proposal information in the storage device in association with the request identifier and the prompt sentence.
Step 8:

The server retrieves, as input, the proposal information from the storage device.

The server parses the proposal information to identify text segments and optional image references or data, and the server may segment the text into attribute fields such as length, neckline, silhouette, and decoration using rule-based parsing.

The server formats the proposal information into display data adapted to the terminal, for example by constructing a structured response that includes textual content and links or identifiers for image resources.

The server outputs the display data and transmits it to the terminal via the network interface.
Step 9:

The terminal receives, as input, the display data from the server.

The terminal parses the display data to extract text and image references, and the terminal loads referenced images from the server or from a content delivery source as needed.

The terminal renders the text on the display device and displays the images in user interface components, thereby presenting the proposal information to the user.

The terminal outputs a visible presentation of the proposed clothing or style and initializes a feedback input interface for further user interaction.
Step 10:

The user observes, as input, the proposal information displayed on the terminal and evaluates whether the proposed design matches personal preferences.

The user operates the feedback input interface and inputs natural-language feedback specifying desired modifications or additional constraints, such as “Make the dress shorter and add a V-neckline, and avoid sequins.”

The terminal receives, as input, the feedback text from the user, validates the text length and encoding, and associates the feedback with the existing request identifier or a proposal identifier.

The terminal constructs, as output, a feedback message including at least the feedback text and the associated identifiers, and transmits the feedback message to the server via the network interface.
Step 11:

The server receives, as input, the feedback message containing the feedback text and identifiers.

The server retrieves the corresponding normalized attribute information from the storage device using the identifiers, and the server analyzes the feedback text using the natural-language processing algorithm to extract modification-oriented keywords.

The server maps these keywords to attribute changes, such as updating a length attribute to indicate a shorter length, setting a neckline attribute to a V-neck, or adding a constraint to exclude specific decorations.

The server updates, as output, the normalized attribute information object to reflect the design change request and stores the updated object in memory, replacing or extending the previous version.
Step 12:

The server receives, as input, the updated normalized attribute information.

The server reconstructs a new prompt sentence by applying the same template mechanism as in Step 6, but now embedding the updated attributes and optionally referencing the previous design.

The server generates, as output, a revised prompt sentence such as “Based on the previous red silk evening dress design, please propose a shorter red silk dress with a V-neckline and no sequins, keeping the overall style elegant and sophisticated.”

The server transmits the revised prompt sentence to the generative AI model using the API interface, thereby initiating another generation cycle that produces updated proposal information.
Step 13:

The server receives, as input, new proposal information generated by the generative AI model in response to the revised prompt sentence.

The server performs the same formatting and storage operations as in Step 8, including parsing the text, handling image data, and constructing updated display data.

The server outputs the updated display data and sends it to the terminal via the network interface.

The terminal receives and displays the updated proposal information to the user, allowing the iterative refinement loop to continue based on further feedback.
Step 14:

The server receives, as input, at least one of the natural-language descriptions, feedback texts, and interaction history associated with the user.

The server applies an emotion estimation algorithm implemented as a classification model that maps textual embeddings and interaction features to emotional state categories, computing scores or probabilities for each category.

The server determines an emotional state label, such as “frustrated” or “satisfied,” based on the computed scores, and the server adjusts internal parameters such as attribute weights, prompt specificity, or generation diversity according to predetermined rules.

The server outputs adjusted normalized attribute information or modified prompt sentences that reflect the estimated emotional state and uses these adjusted data as inputs to subsequent prompt generation and proposal generation, thereby altering the system behavior to better match the user's emotional condition.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional fashion design and virtual try-on systems generally rely on fixed templates, manually curated catalogs, and rule-based recommendation engines operating on simple user profile data. Such systems typically accept limited, form-based inputs (e.g., selecting size, color, or category from predefined options) and do not effectively exploit rich natural language descriptions of user preferences. As a result, these systems cannot flexibly capture nuanced user intent, such as detailed style preferences, contextual usage conditions, or subtle trade-offs between simplicity and decoration.

Furthermore, even where generative models or image-based try-on techniques are used, the role of natural language input is often limited to one-shot prompts that are not structurally analyzed, not iteratively refined, and not tightly integrated with a real-time virtual try-on pipeline. Existing approaches tend to treat the generative model as an isolated component that returns static design proposals, without a feedback loop that updates prompts and design parameters based on user interaction, user evaluation, and emotional state.

In addition, many current systems that provide virtual try-on functionality focus primarily on visual rendering and do not improve the underlying computer technology for managing the end-to-end pipeline from natural language input, through structured attribute extraction, to three-dimensional garment generation and avatar fitting. The processing of natural language descriptions, conversion into structured data, prompt construction for a generative model, and mapping of generated design information into three-dimensional garment data are often implemented in ad hoc, loosely coupled ways. This leads to inefficiencies, such as redundant parsing, non-reusable intermediate representations, and latency or inconsistency between the natural language interface and the 3D visualization.

Moreover, users frequently adjust their preferences iteratively, but conventional systems lack an architecture that treats these iterative natural language refinements as first-class inputs into a controlled generative pipeline. Existing solutions do not systematically maintain and reuse structured representations and prompt sentences across iterations, and they do not incorporate user emotional state information as a parameter for controlling the generative model. As a consequence, the computer system does not effectively adapt the generated designs to the user's affective responses, leading to suboptimal user engagement and requiring repeated manual trial-and-error.

Accordingly, there is a need for an improved computer-implemented system that: (i) structurally analyzes user natural language descriptions into attribute information; (ii) automatically generates and updates prompt sentences for a generative AI model; (iii) converts design information returned by the generative AI model into three-dimensional garment data fitted to a virtual human model; (iv) provides low-latency, 360-degree virtual try-on visualization on a terminal device; and (v) iteratively updates the design based on additional natural language inputs, user feedback, and emotional state. Such a system should improve the functioning of the underlying computer technology by defining specific data structures, processing steps, and control flows that coordinate natural language processing, generative modeling, 3D graphics generation, and interactive rendering in an integrated manner.

The specific processing by the specific processing unit 290 of the data processing device 12 in Application Example 1 is realized by the following means.

The present invention provides a server comprising a processor and a memory storing instructions that, when executed by the processor, cause the server to: control a terminal device to display guidance information prompting a user to input natural language description information representing preferences for garments or accessories, and receive, from the terminal device, the description information entered by the user; analyze the description information to generate structured data by extracting attribute information including at least one of shape, color, material, decoration, use scene, silhouette, and size feeling; generate, on the basis of the structured data, a prompt sentence including the attribute information; transmit the prompt sentence as input to a generative artificial intelligence model and obtain, from the generative artificial intelligence model, response information including design information representing an individual fashion design; convert the design information into three-dimensional garment shape data and surface material data that are associable with skeletal information and body-shape information of a virtual human model; fit the three-dimensional garment shape data to the virtual human model by aligning and deforming the three-dimensional garment shape data based on the skeletal information and the body-shape information, thereby generating virtual try-on visual data; transmit the virtual try-on visual data to the terminal device so that the terminal device renders the virtual human model wearing the garment and allows a 360-degree viewpoint around the virtual human model; receive, from the terminal device, additional natural language description information or correction instruction information as iterative refinement input from the user; update at least one of the structured data, the prompt sentence, and the design information on the basis of the iterative refinement input, and re-execute the generation of the three-dimensional garment shape data and the virtual try-on visual data; acquire information indicating an emotional state of the user and adjust the design information by modifying at least one attribute of the design information based on both the emotional state information and the attribute information; and store the structured data, the prompt sentence, the design information, the virtual try-on visual data, and the emotional state information in association with user identification information for reuse in subsequent design generations. This enables a computer-implemented pipeline that improves the functioning of the underlying computer technology by tightly integrating natural language processing, structured attribute extraction, generative model prompting, three-dimensional garment generation, avatar fitting, and interactive virtual try-on rendering, thereby reducing redundant processing, enabling low-latency iterative refinement, and adaptively controlling the generative AI model based on both explicit user instructions and inferred emotional state.

The term “terminal device” refers to an electronic apparatus operated by a user, such as a mobile communication device, a wearable display device, or a general-purpose computing device, that executes an application program, displays guidance and visual data, receives user input, and communicates with a server over a communication network.

The term “server” refers to an information processing apparatus, including at least one processor and at least one memory, that is configured to perform analysis of user inputs, interaction with a generative artificial intelligence model, generation of design information, generation of three-dimensional data, management of user-related data, and communication with one or more terminal devices.

The term “processor” refers to a hardware processing unit, such as a central processing unit, a graphics processing unit, or a combination thereof, that executes instructions stored in a memory to perform data processing, control operations, and communication functions of the system.

The term “memory” refers to a non-transitory computer-readable storage medium, such as semiconductor memory, magnetic storage, or optical storage, that stores instructions and data to be read and executed or processed by a processor.

The term “natural language description information” refers to information expressed in a human language text, received from a user, that describes preferences, requirements, or constraints regarding garments or accessories, including style, appearance, or usage context.

The term “guidance information” refers to information presented by a terminal device that prompts, instructs, or assists a user to input natural language description information, such as text messages, user interface labels, or on-screen instructions.

The term “attribute information” refers to structured elements derived from natural language description information and representing characteristics of garments or accessories, including, but not limited to, shape, color, material, decoration, use scene, silhouette, and size feeling.

The term “structured data” refers to data arranged in a predefined format, such as a record or data object, that explicitly represents attribute information extracted from natural language description information and is usable as input for subsequent processing modules.

The term “prompt sentence” refers to a natural language instruction or query, generated on the basis of structured data, that is provided as input to a generative artificial intelligence model to cause the model to output design information or other related content.

The term “generative artificial intelligence model” refers to a machine learning model, such as a neural network-based language model or multimodal model, that generates new information, including text or design descriptions, in response to an input such as a prompt sentence.

The term “response information” refers to information output by a generative artificial intelligence model in response to a prompt sentence, including at least design information representing an individual fashion design.

The term “design information” refers to information describing a fashion design for a garment or accessory, including structural, stylistic, and material characteristics, and being suitable for conversion into three-dimensional garment data.

The term “garment shape data” refers to digital data representing a three-dimensional geometry of a garment, including vertices, edges, faces, and related geometric parameters suitable for rendering or simulation.

The term “surface material data” refers to digital data representing material properties of a garment surface, including texture maps, color information, reflectance characteristics, and shading parameters.

The term “virtual human model” refers to a three-dimensional digital representation of a human body, including body-shape information and skeletal information, used as an avatar for visualizing virtual try-on of garments.

The term “skeletal information” refers to data representing a hierarchical structure of bones or joints of a virtual human model, used to control posture, animation, and deformation of the virtual human model and associated garments.

The term “body-shape information” refers to data representing physical dimensions, proportions, and contour characteristics of a virtual human model, such as height, girth, and limb lengths.

The term “virtual try-on visual data” refers to visual representation data, including rendered images, video frames, or three-dimensional scene data, that depicts a virtual human model wearing a garment generated or adjusted according to design information.

The term “360-degree viewpoint” refers to a viewing condition in which a virtual camera or user perspective can be moved around a virtual human model so that the garment can be observed from substantially all horizontal directions around the model.

The term “iterative refinement input” refers to additional natural language description information or correction instruction information, received from a user after an initial design has been generated, which is used to update structured data, prompt sentences, and design information.

The term “correction instruction information” refers to user input specifying modifications, constraints, or preferences for changing an existing design, including requests to adjust color, length, fit, style, or other attributes.

The term “emotional state information” refers to information indicating an affective condition of a user, such as satisfaction, dissatisfaction, excitement, or calmness, which may be derived from explicit user input, sensor data, or analysis of user behavior.

The term “user identification information” refers to data used to distinguish one user from another, such as a user identifier, account identifier, or other unique or pseudonymous identifier.

The term “storage device” refers to a hardware component, such as a database system, file system, or other memory subsystem, that stores structured data, prompt sentences, design information, visual data, and user-related information for later retrieval and reuse.

The term “application program” refers to software executed on a terminal device that provides a user interface for inputting natural language description information, displays virtual try-on visual data, and exchanges data with the server.

The term “evaluation information” refers to information indicating a user's assessment of a presented design, such as a rating, selection, acceptance, rejection, or qualitative comment about the design.

The term “feedback information” refers to information provided by a user that reflects opinions, preferences, or suggested changes concerning a generated design, and that is used to adjust subsequent processing, including structured data, prompt sentences, and design information.

In one embodiment, a server cooperates with one or more terminal devices operated by users to implement a fashion design and virtual try-on system based on natural language input and a generative AI model. The server includes one or more processors and one or more memories that store instructions and data structures for executing the functions described below. The server is implemented, for example, on a rack-mounted computer running a server operating system such as a Linux-based operating system. The terminal is implemented, for example, as a smartphone, a tablet, a head-mounted display, or a general-purpose personal computer running a client application. The terminal includes a display, an input interface such as a touch panel or keyboard, and a network communication module such as a wireless communication interface.

The server uses a combination of software components to perform language processing, prompt sentence construction, interaction with a generative AI model, 3D garment generation, avatar fitting, and virtual rendering management. In one implementation, the server runs an application framework (for example, a web application framework such as a generic server-side framework) and a scripting environment (for example, a Python runtime environment). The server further uses a natural language processing library such as a dependency parser and named entity recognizer (for example, a general-purpose NLP toolkit), and a machine learning framework (for example, a deep learning framework) to execute custom neural network models. For 3D content generation and manipulation, the server uses a 3D graphics engine such as a game engine or a 3D modeling software in headless mode (for example, a command-line capable 3D content creation tool).

The terminal displays guidance information that prompts the user to input natural language description information about preferred garments or accessories. The terminal executes an application program, such as a native mobile application or a web application using a rendering engine (for example, a browser with WebGL support), and renders a user interface that includes text fields, buttons, and visualization areas. The terminal receives the user's natural language description and sends this description, along with metadata such as language indicator and user identification information, to the server via a network using HTTPS.

The server receives the natural language description information and analyzes it to generate structured data representing attribute information. The server executes a text analysis module that includes at least one neural network-based sequence model (for example, a bidirectional recurrent neural network or a transformer-based encoder) trained on fashion-related corpora. The server uses tokenization, part-of-speech tagging, dependency parsing, and named entity recognition to identify terms corresponding to garments, colors, materials, styles, decorations, intended occasions, silhouette preferences, and size preferences. The server then maps these recognized terms into a normalized attribute schema. For example, the server converts “a blue casual denim jacket with a simple design” into an internal representation with fields such as “category: outerwear,” “type: jacket,” “material: denim,” “color: blue,” “style: casual,” and “decorative_complexity: low.”

The server represents the structured data in a predefined data structure, such as a key-value map or an object containing arrays of attribute-value pairs. This internal representation is stored in memory and, optionally, in a database. By using a structured representation, the server avoids re-parsing of raw text for subsequent iterations and supports more efficient indexing and retrieval of historical preferences. This improves processing speed and reduces CPU load when multiple iterative refinements are requested by the same user.

The server constructs a prompt sentence for a generative AI model on the basis of the structured data. The server executes a prompt generation module that takes as input the attribute information and any contextual information from previous iterations. The prompt generation module uses rule-based templates combined with neural language generation. For example, the server may use a template such as: “Design a [style] [color] [material] [type] suitable for [use_scene]. Keep the design [decorative_complexity]. Describe the cut, fit, details, and stitching.”

The server fills in the slots with normalized attribute values. In the above example, the server generates a prompt such as: “Design a simple, casual blue denim jacket suitable for everyday wear. Use a relaxed fit and minimal decorations. Describe the cut, length, pocket placement, and stitching details in detail.”

The server may further refine the prompt sentence using a neural text generator to add constraints such as “avoid logos,” “suitable for spring,” or “provide options for sleeve length.” This structured prompt construction, rather than passing the raw user text directly to the generative AI model, reduces ambiguity and leads to more stable and accurate generative output, thereby improving computational efficiency and model prediction quality.

The server transmits the generated prompt sentence to a generative AI model. In one embodiment, the generative AI model is a large-scale transformer-based neural network language model hosted as a remote service accessible via an API. The generative AI model includes multiple layers of self-attention mechanisms, feed-forward networks, and normalization layers, trained on large-scale text corpora. The server uses an HTTPS client library (for example, a generic HTTP client in the scripting environment) to call the model's API. The server sends the prompt sentence, along with model configuration parameters such as maximum token length, temperature, and top-k sampling parameters.

The server receives response information from the generative AI model. The response information contains, for example, a detailed textual description of an individual fashion design. The generative AI model generates this description by computing attention-weighted representations of tokens in the prompt sentence and iteratively sampling the next token according to a probability distribution over the vocabulary, which is computed using learned weights and a softmax output layer. The weights in the model are trained offline using a gradient-based optimization method such as stochastic gradient descent with an adaptive learning rate, where a cross-entropy loss function is minimized between predicted tokens and ground-truth tokens on large-scale training data. During inference, the server does not update the model weights, but the server can use different decoding strategies (for example, greedy decoding or nucleus sampling) to balance diversity and determinism.

The server parses the generative model's textual output to extract design information and convert it into a machine-usable representation. The server uses a second-stage parser or rule-based extractor to identify explicit details in the generated description, such as “waist-length,” “two chest pockets without flaps,” “button closure,” “collar shape,” and “stitching style.” The server maps these elements into a parametric garment model specification, which the 3D engine will use to generate or modify a 3D mesh. By using a parametric model, the server can control specific geometric parameters (for example, sleeve length, torso length, waist circumference) and material parameters (for example, normal maps, roughness, albedo color) through well-defined numerical fields.

The server generates 3D garment shape data based on the design information. In one embodiment, the server uses a 3D engine such as a game engine or a command-line driven 3D modeling tool that supports scripting. The server loads a base garment mesh corresponding to a generic jacket and applies morph targets or deformation operations to match the desired parameters. For example, the server adjusts vertex positions along the vertical axis to set the jacket length as “waist-length,” adjusts horizontal scaling to implement a “relaxed fit,” and adds or removes mesh elements representing pockets. Texture generation is performed by assigning material files and texture maps, which may be selected from a library of denim materials tagged with attributes such as “blue,” “dark navy,” and “light wash.” The server modifies shader parameters to control glossiness, roughness, and normal mapping, so that the virtual fabric appearance matches the design information.

The server associates the generated garment shape data and the surface material data with a virtual human model. The virtual human model includes skeletal information and body-shape information. The skeletal information is represented as a hierarchy of bones and joints, each with transformation matrices. The body-shape information is represented as a set of parameters that control a body morph system (for example, height, torso length, chest circumference, waist circumference, hip circumference, and limb lengths). The server performs skinning by computing bone-weight assignments for vertices of the garment mesh and applying linear blend skinning or dual quaternion skinning. The server further executes collision detection and cloth simulation algorithms, such as mass-spring systems or position-based dynamics, to prevent mesh penetration and to simulate realistic draping. These algorithms compute forces and constraints at each vertex based on physical parameters, and update vertex positions by iteratively solving constraint equations.

The server generates virtual try-on visual data by rendering the virtual human model wearing the garment. The server uses the 3D engine's rendering pipeline to rasterize the scene, apply lighting calculations, and generate images from multiple viewpoints around the avatar. In an alternative configuration, the server generates a 3D scene file in a standard format such as a generic 3D transmission format along with associated textures, and the terminal performs rendering locally. In either case, the server's management of the data structures for meshes, skeletons, and camera parameters reduces redundant data transfer and allows more efficient use of GPU resources, thereby improving rendering performance and reducing latency.

The terminal receives the virtual try-on visual data and presents an interactive 360-degree view. The terminal uses a rendering engine, such as a mobile 3D engine or a browser-based WebGL framework, to load the 3D scene and render the avatar wearing the jacket. The terminal maps user input events (for example, swipe gestures or mouse drag) to camera rotation around the avatar, and maps pinch gestures to changes in camera distance. This allows the user to visually inspect details such as stitching and pockets from different angles.

The user observes the virtual try-on result and may provide additional natural language description information or correction instruction information. For example, the user may input:

“Make the denim jacket a darker navy blue and slightly shorter, with a more fitted silhouette.”
or in another language:

“Please generate a blue casual denim jacket. Keep the design simple.”

The terminal sends these refinement instructions to the server. The server integrates the refinement instructions with the existing structured data. Instead of treating each instruction as a new isolated request, the server's refinement module computes a delta representation that records which attributes are changed and how. For example, “color: blue” is updated to “color: dark navy,” “length: waist-length” is updated to “length: slightly shorter,” and “fit: relaxed” is updated to “fit: more fitted.” The server then updates the prompt sentence by explicitly referencing that the new design should modify the previous one, for example: “Modify the previous simple, casual blue denim jacket design by changing the denim to a darker navy color and making the jacket slightly shorter, with a more fitted silhouette. Keep minimal decorations and clean lines.”

By maintaining and updating structured data and prompt sentences in this way, the server reduces the amount of text that must be re-analyzed and provides more precise instructions to the generative AI model. This leads to faster convergence of the iterative design process and reduces computational cost compared to re-running a full design generation from scratch on each iteration.

The server acquires information indicating an emotional state of the user. In one embodiment, the terminal collects explicit emotional indications, such as selecting mood icons or rating scales, and transmits them to the server. In another embodiment, the server analyzes linguistic cues in user feedback, such as positive or negative sentiment, using a sentiment analysis model implemented as a neural classifier trained with a labeled sentiment dataset. The classifier uses features such as word embeddings and attention over tokens to output a probability distribution over emotional categories. The server stores the resulting emotional state information along with the corresponding design information and user identification information.

The server adjusts the design information based on both attribute information and emotional state information. For example, if the sentiment analysis indicates user dissatisfaction and the structured data shows repeated requests for “more simple” or “less flashy” designs, the server modifies the prompt generation rules for this user by lowering a numerical parameter representing decoration density and by adding explicit constraints such as “avoid bright contrast stitching” or “remove unnecessary embellishments.” These modifications are encoded into the prompt sentence and the parametric garment model specification. As a result, the generative AI model receives more restrictive and personalized instructions, improving the likelihood that the subsequent design output aligns with the user's emotional preferences. This feedback loop improves the technical functioning of the system by reducing the number of iterations needed to reach user satisfaction and by optimizing server utilization. The server stores the structured data, prompt sentences, design information, virtual try-on visual data, and emotional state information in a storage device, such as a relational database or a document database. The server uses indexed fields for user identification information and time stamps, thereby enabling efficient retrieval of past designs and emotional responses. When the same user later initiates a new design session, the server can retrieve prior data and pre-populate attribute information and prompt generation parameters. This reduces the amount of processing required for new sessions and allows the server to personalize the initial design proposals, which improves overall throughput and responsiveness of the system.

From a technical perspective, the described architecture and data flow improve computer technology in several ways. First, the separation of concerns between raw natural language input, structured attribute data, prompt sentences, generative AI responses, and 3D garment parameters allows the server to avoid redundant natural language parsing and to reuse intermediate representations efficiently. Second, the use of parametric garment models and rule-based mapping from textual design attributes to numeric parameters enables deterministic and controllable 3D generation, which is more computationally efficient than manually editing 3D meshes or relying solely on image-based generation. Third, the iterative refinement mechanism, which updates both structured data and prompt sentences, provides a machine-centric optimization loop that minimizes unnecessary network calls and reduces overall latency. Fourth, the integration of emotional state information into the design generation pipeline allows the system to adapt model instructions in a way that lowers the number of failed or unsatisfactory generations, thereby reducing server-side computation over time.

In contrast to simple automation of human tasks, the server performs specialized computational tasks that humans cannot efficiently perform manually, such as high-speed parsing of natural language into structured attributes, real-time control of a large generative AI model via systematically constructed prompt sentences, automated mapping of textual design descriptions into numerical mesh parameters, and dynamic allocation of GPU and CPU resources for multi-user 3D rendering. The server implements specific algorithms and data structures that change the way the computer operates, leading to improved processing speed, improved accuracy of generated designs, reduced communication overhead, and more efficient memory utilization.

In another embodiment, the server uses an alternative neural architecture for the generative AI model interaction. For example, the server may host a smaller, locally running transformer model trained specifically on fashion descriptions. The server may use a two-stage generative pipeline, where an initial model generates coarse design attributes, and a second model refines details based on the user's emotional state and historical preferences. The server may also apply data augmentation techniques on training data, such as synonym replacement for style descriptors or controlled noise injection in length and fit parameters, to increase the robustness of the attribute extraction and prompt generation pipelines.

In yet another embodiment, the server supports different types of terminal devices, such as head-mounted displays for mixed reality or smart mirrors. In such a configuration, the terminal renders the avatar and garments overlaid on a reflection or live camera feed of the user, using pose estimation and real-time tracking. The server still provides 3D garments and design updates, but the terminal performs additional calculations such as skeletal tracking and camera pose estimation using an on-device vision module. This embodiment shows that the described system can be used in various real-world scenarios and that the technical improvements in data management, model control, and 3D rendering coordination are beneficial across heterogeneous hardware environments.

Through these embodiments and variations, the server, the terminal, and the user interact in a coordinated manner to implement the claimed system. By defining specific data structures, neural network configurations, prompt sentence generation rules, and 3D garment generation algorithms, the system achieves technical effects such as improved processing speed, improved design accuracy, reduced error rates in attribute extraction, decreased communication load, and enhanced computational efficiency in three-dimensional rendering.

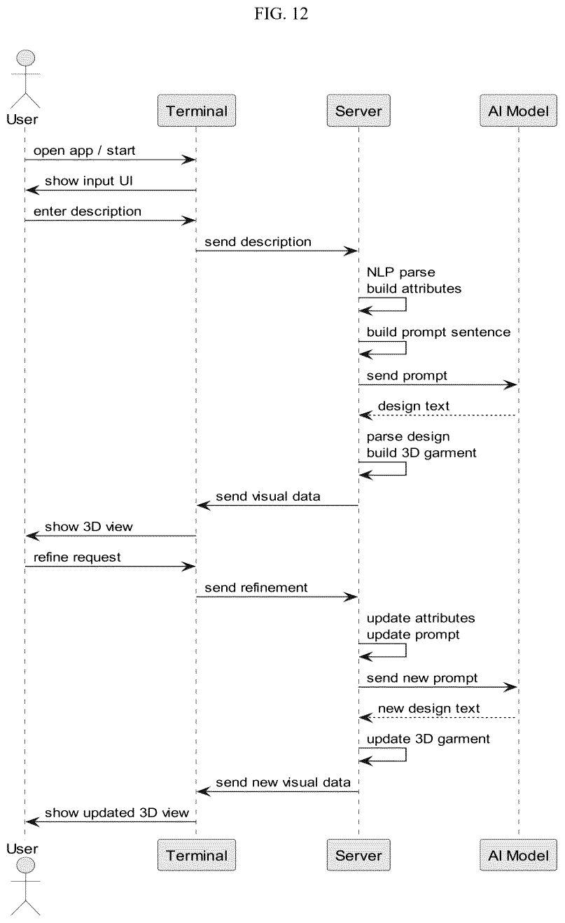

The following describes the processing flow using FIG. 12.
Step 1:

The user operates the terminal to launch an application and start a new design session.

The user opens a fashion design and virtual try-on application on the terminal and selects a function such as “Create New Design” or “Virtual Try-On.” The terminal initializes a new session identifier and displays an input screen for natural language description.

Input: User interaction (app launch, menu selection).

Output: A session context on the terminal including a session ID and an empty input field for natural language description.
Step 2:

The terminal displays guidance information and receives natural language description information from the user.

The terminal presents guidance text such as “Please describe your preferred clothing style in your own words” and renders a text input box. The user types or dictates sentences such as “I like a blue casual denim jacket with a simple design” or “Please generate a blue casual denim jacket. Keep the design simple.” The terminal captures this text and associates it with the current session ID.

Input: User keystrokes or speech-to-text result.

Output: A data object on the terminal containing the session ID and the raw natural language description string.
Step 3:

The terminal packages the description and sends it to the server.

The terminal constructs a request message including the user identifier, the session ID, the language code, and the natural language description. The terminal serializes this information into a structured format and transmits the message to the server via a secure network protocol.

Input: The session data object (user ID, session ID, language, description text).

Output: A network request delivered to the server containing the raw description and associated metadata.
Step 4:

The server receives and stores the raw description.

The server accepts the network request, validates authentication tokens, and extracts the payload fields. The server writes the raw description, the user identifier, and the session ID into a persistent data store for logging and later reference.

Input: The network request with raw description and metadata.

Output: Stored raw description record and an in-memory representation of the request for further processing.
Step 5:

The server normalizes the natural language description.

The server converts the text to a uniform character encoding, removes unnecessary control characters, and, if necessary, performs language detection. If the description is in a different language than the processing language, the server uses a machine translation module to translate the text into the processing language.

Input: Raw description string and language metadata.

Output: A normalized, possibly translated, description string ready for linguistic analysis.
Step 6:

The server extracts attribute information and generates structured data.

The server runs a natural language processing pipeline using tokenization, part-of-speech tagging, and entity extraction. The server identifies terms indicating garment type, material, color, style, decorative complexity, silhouette, size feeling, and use scene. The server maps these terms to predefined attribute keys and values, producing a structured representation such as a key-value map.

Input: The normalized description string.

Data processing: The server segments the string into tokens, assigns linguistic labels, applies pattern rules and trained models to classify segments into attribute categories, and normalizes synonyms into canonical attribute values.

Output: Structured data containing attribute information, for example {item: “jacket”, material: “denim”, color: “blue”, style: “casual”, decorative_complexity: “simple”}.
Step 7:

The server constructs a prompt sentence for the generative AI model.

The server passes the structured data to a prompt generation module. The module selects a template and fills template slots with the extracted attributes. The server may add explicit constraints and clarification phrases that are not directly present in the user text but are derived from system defaults.

Input: Structured attribute data.

Data processing: The server matches each attribute key to a corresponding phrase, orders the phrases according to a predefined schema, and concatenates them into a fluent natural language sentence.

Output: A prompt sentence such as “Design a simple, casual blue denim jacket suitable for everyday wear. Use a relaxed fit and minimal decorations. Describe the cut, length, pocket placement, and stitching details.”
Step 8:

The server sends the prompt sentence to the generative AI model and obtains response information.

The server calls a generative AI model interface using a network API. The server sends the prompt sentence and generation parameters such as maximum length and sampling temperature. The generative AI model, implemented as a transformer-based neural network, processes the prompt and generates a textual response describing a specific fashion design.

Input: Prompt sentence and generation parameters.

Data processing: On the model side, the prompt is tokenized, encoded into vector representations, passed through attention layers and feed-forward layers, and decoded token by token according to a learned probability distribution; the server simply sends and receives data.

Output: Response information containing a detailed design description in natural language.
Step 9:

The server parses the design description and forms design information.

The server analyzes the response text using pattern matching and semantic parsing. The server extracts explicit design elements, such as garment length (“waist-length”), closure type (“button front”), pocket configuration (“two chest pockets without flaps”), and collar style. The server maps these elements into a parametric design information structure compatible with a 3D garment model.

Input: The generative AI model's response text.

Data processing: The server applies a second-stage parser and rules to identify phrases referring to physical features, converts descriptive adjectives into numeric or categorical parameters, and stores these as fields in a design information object.

Output: Design information object with parameters suitable for 3D generation.
Step 10:

The server generates 3D garment shape data and surface material data.

The server passes the design information to a 3D generation module. The module selects a base mesh for the specified garment type and applies numerical modifications to mesh control points to reflect parameters such as length, fit, and pocket placement. The server selects material definitions corresponding to the specified fabric and color and associates relevant texture maps.

Input: Design information parameters.

Data processing: The server computes geometric transformations for the base mesh, such as scaling and vertex offsets, adds or removes submeshes for design features, and assigns material identifiers and texture references.

Output: 3D garment shape data (mesh representation) and surface material data (texture and shader parameters).
Step 11:

The server fits the garment data to a virtual human model and generates virtual try-on visual data.

The server retrieves a virtual human model associated with the user's body-shape information and skeletal structure. The server assigns skinning weights to the garment mesh, aligns the garment to the skeleton pose, and runs collision resolution and cloth simulation. The server then renders one or more views or prepares a 3D scene description for use by the terminal.

Input: 3D garment shape data, surface material data, virtual human model (skeleton and body-shape).

Data processing: The server performs coordinate alignment, applies skinning matrices, executes physics simulation steps to adjust garment vertices, and computes rendered images or packages scene graphs.

Output: Virtual try-on visual data (rendered images or 3D scene files) showing the avatar wearing the garment.
Step 12:

The server transmits the virtual try-on visual data to the terminal.

The server encapsulates the visual data into a response message associated with the session ID and sends it via the network. If the data is a 3D scene, the server may compress mesh and texture data to reduce size.

Input: Virtual try-on visual data and session metadata.

Data processing: The server encodes the data into a transferable format, attaches identifiers, and sends it over a secure connection.

Output: A network response containing the virtual try-on visual data delivered to the terminal.
Step 13:

The terminal renders the virtual human model and enables 360-degree viewing.

The terminal receives the visual data and loads it into its rendering component. The terminal displays the avatar wearing the garment on the screen and maps user gestures to camera transformations. When the user swipes, the terminal rotates the camera around the avatar; when the user pinches, the terminal zooms in or out.

Input: Virtual try-on visual data and user interaction events.

Data processing: The terminal decodes scene data or images, sets up a render loop, updates camera position according to input events, and redraws the scene.

Output: An interactive visual presentation allowing the user to inspect the design from various angles.
Step 14:

The user evaluates the displayed design and optionally provides iterative refinement input.

The user looks at the avatar wearing the generated garment and decides whether changes are needed. The user may input a refinement such as “Make the denim jacket a darker navy blue and slightly shorter, with a more fitted silhouette.” The terminal captures this refinement as new natural language description information associated with the same session ID.

Input: The current virtual try-on display and user judgment.

Output: A new refinement description string stored on the terminal for transmission to the server.
Step 15:

The terminal sends refinement input to the server.

The terminal creates a new request including the session ID, user identifier, and the refinement text. The terminal may also include references to the current design information identifier so that the server can treat the new input as a modification rather than a fresh design.

Input: Refinement description text and existing session metadata.

Output: A refinement request transmitted to the server.
Step 16:

The server updates structured data and prompt sentence based on the refinement.

The server parses the refinement text using the same NLP pipeline and identifies attribute changes, such as color darkening or silhouette adjustment. The server updates the previously stored structured data by overwriting or augmenting specific fields. The server then regenerates a prompt sentence that explicitly instructs modification of the previous design rather than creating a completely new design.

Input: Refinement text, previous structured data, and design information.

Data processing: The server computes a difference between old and new attributes, applies update rules to the data structure, and reconstructs a new prompt sentence that references the prior design context.

Output: Updated structured data and an updated prompt sentence for the generative AI model.
Step 17:

The server obtains updated design information from the generative AI model.

The server sends the updated prompt sentence to the generative AI model, receives a revised design description, and parses it into updated design information. The server modifies the 3D garment shape data accordingly, for example by changing the color to dark navy, shortening the length, and tightening the fit parameters.

Input: Updated prompt sentence and existing design information.

Data processing: The server requests new generative output, extracts modifications, and adjusts parametric values in the garment specification.

Output: Updated design information object aligned with the user's refinement request.
Step 18:

The server regenerates virtual try-on visual data and sends it to the terminal.

The server re-applies fitting and rendering operations using the updated garment parameters while reusing previously computed elements such as avatar geometry and skeleton. This incremental update reduces computation time. The server then transmits the new virtual try-on visual data to the terminal.

Input: Updated design information and existing avatar data.

Data processing: The server recomputes only changed mesh and material attributes, refreshes the rendered views or scene, and packages the results for transfer.

Output: Updated virtual try-on visual data reflecting the refined design.
Step 19:

The server acquires and utilizes emotional state information to adjust future designs.

The server receives explicit emotional ratings from the terminal or infers emotional state from user feedback text using a sentiment analysis model. The server stores this emotional state along with the structured data and design information. When later generating prompt sentences and selecting design parameters, the server uses this stored emotional state to bias attribute values toward those historically associated with positive emotional responses for that user.

Input: User ratings or sentiment-labeled feedback and existing design/session records.

Data processing: The server classifies feedback into emotional categories, updates user-specific preference profiles, and adjusts rules or weights used in prompt construction and parameter selection.

Output: Updated user preference and emotional profiles that influence subsequent prompt sentences and generative AI model interactions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented fashion design systems that utilize machine learning or rule-based engines are limited in their ability to accurately reflect a user's individual preferences in generated fashion designs. Existing systems typically accept static preference inputs and then generate designs in a one-shot manner, without efficient mechanisms for iterative refinement based on user feedback or user emotion. As a result, such systems often produce outputs that are only loosely aligned with user intent, and require substantial manual intervention to adjust designs. This leads to increased computational overhead on the server side due to repeated ad hoc design generation, inefficient use of generative models, and degradation of user experience.

Furthermore, known generative AI model interfaces in the fashion domain generally treat prompt sentences as unstructured text, without systematically structuring extracted fashion elements (such as color, material, clothing type, silhouette, decorative elements, and usage scene) and without persistently associating such structured data with user feedback and emotion information. In these configurations, servers cannot effectively reuse prior interaction data to guide subsequent inference conditions of the generative AI model. Consequently, the models are repeatedly invoked with context-poor prompts, resulting in redundant computation, latency, and inconsistent design quality.

In addition, typical systems that provide virtual fitting experiences are decoupled from generative AI-based design pipelines. These systems often rely on pre-authored assets and manually configured mappings between garments and avatar body shapes. This separation makes it difficult to automatically transform newly generated fashion designs into formats suitable for virtual try-on, and to feed back virtual fitting results into the generative pipeline. As a result, the integration between design generation, presentation, and virtual fitting is fragmented, and servers cannot systematically incorporate virtual fitting feedback into the optimization of subsequent designs.

Accordingly, there is a need for a computer-implemented technique that improves the operation of servers, terminals, and generative AI models by: (i) structuring user preference inputs into fashion elements in a machine-processable form; (ii) generating and managing prompt sentences and image-generation prompt sentences in a manner that incorporates user feedback and emotion information; (iii) persistently storing and associating user-specific design data, feedback data, and emotion data to inform subsequent inferences; and (iv) converting generated fashion designs into data formats directly usable by virtual fitting applications and reusing virtual fitting feedback. By addressing these needs, it becomes possible to improve computational efficiency, reduce redundant processing, stabilize design quality, and enhance the overall performance of the computer system that provides AI-based fashion design and virtual fitting services.

The specific processing by the specific processing unit 290 of the data processing device 12 in Example 2 is realized by the following means.

The present invention provides a server comprising a processor and a memory storing instructions that, when executed by the processor, cause the server to cooperate with an information processing terminal operated by a user and at least one generative AI model, the processor being configured to: receive, via a communication interface, a natural language input sentence including information about a user's preferred clothing and style acquired from the information processing terminal; generate, based on the natural language input sentence, a first prompt sentence; invoke a generative AI model using the first prompt sentence to parse the first prompt sentence and to extract, as structured fashion elements, at least a color, a material, a clothing type, a silhouette, a decorative element, and a usage scene, and to generate, based on the structured fashion elements, an individualized fashion design description text; generate, based on the fashion design description text, an image-generation prompt sentence; invoke an image-generation generative AI model using the image-generation prompt sentence to generate fashion design image data; store, in a storage device, the structured fashion elements, the fashion design description text, and the fashion design image data as structured data associated with a user identifier; transmit the fashion design description text and the fashion design image data to the information processing terminal for presentation to the user; receive, from the information processing terminal, feedback information including at least a design change request or an evaluation, and emotion information representing a recognized emotion of the user; reconstruct at least one of the first prompt sentence and the image-generation prompt sentence by embedding the feedback information and the emotion information as additional conditions; iteratively invoke at least one of the generative AI model and the image-generation generative AI model using the reconstructed prompt sentence to update the fashion design description text and the fashion design image data; store, in the storage device, the feedback information and the emotion information in association with the structured fashion elements, the fashion design description text, and the fashion design image data for the user; and convert at least the fashion design description text and the fashion design image data into a format applicable to body shape information of the user in a virtual space and provide the converted data to a virtual fitting application operating on at least one information processing device. This enables the server to systematically manage prompt sentences, structured fashion elements, user feedback, and emotion information in an integrated data model, to reduce redundant generative processing by reusing stored interaction data as inference conditions for the generative AI model, to automatically produce fashion design representations suitable for virtual fitting applications, and thereby to improve the technical performance, responsiveness, and design quality consistency of a computer system implementing AI-based fashion design and virtual try-on functionalities.

The term “system” refers to a collection of one or more hardware devices and software components that cooperate via at least one communication interface to execute the processing described in the claims.

The term “processor” refers to a hardware computation unit, such as a central processing unit or a graphics processing unit, that executes instructions to perform arithmetic, logical, control, and input/output operations.

The term “memory” refers to a hardware storage medium, such as volatile memory or non-volatile memory, that stores instructions and data to be accessed and processed by the processor.

The term “information processing server” refers to an information processing apparatus including at least one processor, a memory, and a communication interface, which executes server-side processing including reception, analysis, storage, and generation of data related to fashion designs.

The term “information processing terminal” refers to an information processing apparatus operated by a user, including at least one processor, a memory, a communication interface, and a display device, which transmits user input to the information processing server and presents results received from the information processing server.

The term “communication interface” refers to a hardware and software component that enables data exchange between the information processing server and the information processing terminal via a wired or wireless communication network.

The term “natural language input sentence” refers to a sequence of characters or tokens expressed in a human language, including at least text describing clothing or style preferences of a user.

The term “prompt sentence” refers to a natural language text constructed from at least a user input and optional additional conditions, which is provided as an input to a generative AI model to control or guide its output.

The term “image-generation prompt sentence” refers to a prompt sentence specifically formatted to describe visual characteristics of a fashion design and to be used as an input condition for an image-generation generative AI model.

The term “generative AI model” refers to a software-implemented artificial intelligence model, such as a neural network model, configured to generate output data including at least text based on input data such as a prompt sentence.

The term “image-generation generative AI model” refers to a generative AI model configured to generate image data representing at least a fashion design based on an image-generation prompt sentence.

The term “fashion element” refers to a structured attribute extracted from a user input or a prompt sentence, including at least one of a color, a material, a clothing type, a silhouette, a decorative element, and a usage scene.

The term “color” refers to a visual attribute of a fashion design, such as a hue, saturation, or brightness, that characterizes the appearance of clothing.

The term “material” refers to a type or category of fabric or substance used in a clothing item, such as textile, leather, or synthetic fiber.

The term “clothing type” refers to a category of garment, such as a dress, coat, shirt, trousers, or similar apparel classification.

The term “silhouette” refers to an overall shape or outline of a garment as perceived when worn, including aspects such as fit, flare, and length.

The term “decorative element” refers to a design detail applied to a garment, such as lace, embroidery, buttons, patterns, or trims, which contributes to visual ornamentation.

The term “usage scene” refers to an intended use context or occasion for wearing a garment, such as everyday wear, formal events, business situations, or leisure activities.

The term “fashion design description text” refers to a text generated by a generative AI model that describes a fashion design in natural language, including at least one fashion element and optional additional design details.

The term “fashion design image data” refers to digital image data representing a visual depiction of a fashion design generated by an image-generation generative AI model.

The term “structured data” refers to data organized in a predefined schema or format, such as key-value pairs, records, or tables, enabling systematic storage, retrieval, and processing by the server.

The term “storage device” refers to a hardware component or system, such as a database system, a file system, or other persistent storage, that stores data including at least structured data related to fashion designs.

The term “database” refers to an organized collection of structured data stored in a storage device and managed by a database management system to enable querying, updating, and associating records.

The term “user identifier” refers to data that uniquely identifies or distinguishes a user within the system, and that may be used to associate design data, feedback information, and emotion information with that user.

The term “display device” refers to hardware such as a screen, monitor, or other visual output unit of the information processing terminal that presents text and image data to the user.

The term “feedback information” refers to information received from a user in response to a presented fashion design, including at least a design change request, an evaluation, a rating, or a comment.

The term “emotion information” refers to data representing an estimated or recognized emotional state of a user, such as satisfaction, dissatisfaction, interest, or disinterest, obtained through explicit input or automated analysis.

The term “reconstruct” refers to process of generating a new version of at least one prompt sentence by adding, editing, or removing conditions or elements based on feedback information or emotion information.

The term “iteratively invoke” refers to repeatedly executing at least one generative AI model multiple times in sequence, each time using updated prompt sentences or conditions derived from previous outputs or user feedback.

The term “body shape information” refers to data representing physical characteristics of a user's body, such as size, dimensions, or proportions, used to adapt a fashion design to a virtual avatar.

The term “virtual space” refers to a computer-generated three-dimensional or two-dimensional environment in which representations of garments and user avatars can be displayed and manipulated.

The term “virtual fitting application” refers to a software application configured to apply fashion design data to a representation of a user's body shape in a virtual space and to present a virtual try-on or fitting experience.

The term “virtual fitting experience” refers to a user-perceivable presentation in a virtual space showing how a generated fashion design would appear when worn by a user or an avatar corresponding to the user.

In one embodiment, a server cooperates with a terminal operated by a user to implement the claimed system for generating, updating, and virtually fitting fashion designs using a generative AI model. The server includes at least one processor, a memory, a communication interface, and a storage device implemented, for example, by a general-purpose server computer equipped with a multi-core central processing unit and at least one graphics processing unit. The terminal includes at least one processor, a memory, a communication interface, and a display device implemented, for example, by a smartphone, a tablet device, or a personal computer.

The server executes an operating system such as a general-purpose server operating system and an application framework such as a web application framework or an application programming interface framework. The terminal executes a client-side application such as a web browser or a native application. The server and the terminal communicate over a packet-switched network through the communication interfaces using a secure transport protocol such as an encrypted hypertext transfer protocol.

The user uses the terminal to start a client-side application. The terminal presents an input field on the display device by executing a graphical user interface. The user inputs, as text, preference information describing desired clothing and style. For example, the user may input the following natural language sentence:

“The user prefers a red silk dress with long sleeves for an evening party.”

The terminal converts the input text into a sequence of characters encoded in a character encoding scheme and generates a structured request message including the text and a user identifier stored in a local memory. The terminal sends the request message to the server via the communication interface.

The server receives the request message and stores the received data in the storage device through a database management system. The server extracts the natural language sentence from the request message and constructs a prompt sentence. In one example, the server generates the following prompt sentence:

“Act as a professional fashion designer. The user prefers the following clothing: ‘a red silk dress with long sleeves for an evening party’.
1) Extract and list the fashion elements: color, material, clothing type, sleeve style, length, silhouette, decorative elements, and usage scene.
2) Based on these elements, write a detailed fashion design description that can later be used to generate an image.”

The server constructs the prompt sentence by combining the user input with a template stored in the memory. The template defines a fixed instruction part and a variable part to be filled with the user input. The server uses a deterministic string concatenation or template-substitution process to avoid ambiguity and to provide a consistent structure that can be systematically parsed by a generative AI model.

The server provides the prompt sentence to a generative AI model. In one embodiment, the generative AI model includes a transformer-type neural network implemented using a machine learning framework. The generative AI model includes an input embedding layer, a plurality of transformer blocks each including a multi-head self-attention layer and a position-wise feedforward layer, and an output projection layer. The generative AI model uses a vocabulary and a tokenizer. The tokenizer converts the characters of the prompt sentence into a sequence of token identifiers according to a subword segmentation scheme such as byte-pair encoding or similar segmentation. The input embedding layer maps each token identifier to a continuous vector, and the transformer blocks propagate information through attention mechanisms that compute similarity scores between tokens and weighted sums of value vectors.

In this embodiment, the server stores, in advance, parameters of the generative AI model that were obtained through supervised pre-training and fine-tuning. The server executes the generative AI model in an inference mode. The server supplies the token identifiers of the prompt sentence to the generative AI model. The generative AI model computes hidden representations and generates output tokens that form a response text. The response text is designed to contain a section listing structured fashion elements and a section containing a detailed fashion design description text.

The server parses the response text to extract the fashion elements. In one embodiment, the server instructs the generative AI model, through the prompt sentence, to output the fashion elements in a predetermined labeled form, such as lines beginning with specific labels “Color:”, “Material:”, “Clothing type:”, “Sleeve style:”, “Length:”, “Silhouette:”, “Decorative elements:”, and “Usage scene:”. The server uses a pattern-matching algorithm implemented by the processor to detect these labels and to extract corresponding values. The server then converts the extracted fashion elements into structured data, for example, into a record including fields such as color, material, clothing type, silhouette, decorative elements, and usage scene. This structuring enables efficient indexing and retrieval by the database management system and enables subsequent processing to reuse elements without re-parsing free text.

The server also stores the fashion design description text, which is a part of the response text, in association with the fashion elements and the user identifier. This association allows the server to reconstruct prior designs and to generate incremental updates without recomputing all elements from scratch. As a result, technical effects such as reduction in computation time, improved cache locality within the storage device, and decreased number of generative model invocations can be achieved.

In one embodiment, the server generates a second prompt sentence for an image-generation generative AI model. The server extracts key attributes from the structured fashion elements and from the fashion design description text in order to compose the second prompt sentence in a concise but image-oriented description format. For example, the server may generate the following image-generation prompt sentence:

“High-resolution fashion illustration of an elegant knee-length red silk dress with long sleeves, fitted waist, slightly flared skirt, subtle lace details at the cuffs, V-neckline, suitable for an evening party, front view, neutral studio background.”

The server passes the image-generation prompt sentence to an image-generation generative AI model. In one embodiment, the image-generation generative AI model includes a diffusion-based neural network. The diffusion-based model includes a text encoder, a noise scheduler, and a denoising network. The text encoder is implemented, for example, as another transformer-type network that converts the prompt sentence into a sequence of context embeddings. The denoising network is implemented as a convolutional or attention-based network that receives, as inputs, an image latent representation and the context embeddings.

The server initializes the image latent representation as random noise and iteratively applies the denoising network according to a predefined schedule. At each iteration, the denoising network computes an estimate of noise residuals and updates the latent representation to reduce noise while aligning with the semantic information contained in the prompt sentence. After a predetermined number of iterations, the server obtains an image latent representation corresponding to a synthesized fashion design. The server then converts the latent representation into a pixel image using a decoder network, and stores the resulting fashion design image data as an image file in the storage device.

The server thus transforms textual preference information entered by the user into image data in a multi-stage process involving structured fashion element extraction and controlled image synthesis. This pipeline achieves improved reproducibility of designs and reduces artifacts because the image generation is guided by a structured and semantically rich prompt rather than by loosely specified free text.

The terminal receives the fashion design description text and the fashion design image data from the server and displays them to the user. The user visually checks the design on the terminal. The user then optionally provides feedback by entering natural language comments or selecting evaluation options. For example, the user may input:

“Make the dress shorter and add lace around the neckline.”

The terminal transmits this feedback information to the server. In one embodiment, the server also determines or receives emotion information representing the user's emotional state in relation to the presented design, such as satisfaction level or interest level. The emotion information may be obtained from explicit user input or may be computed by another module in the system, for example, by analyzing user interaction patterns or biometric signals, although the specific method for obtaining emotion information may vary among embodiments.

The server reconstructs a new prompt sentence by embedding the feedback information and the emotion information into the prompt. For example, the server may generate the following prompt sentence:

“The current dress design is: [current fashion design description text].

The user feedback is: ‘Make the dress shorter and add lace around the neckline.’

The user's emotion indicates moderate satisfaction but a desire for more decorative detail.

Revise the design according to this feedback and emotion. Keep the main concept (red silk, long sleeves, elegant evening style), but adjust the length and neckline decoration. Output a new, complete fashion design description and updated fashion elements.”

By embedding the feedback and emotion information as explicit conditions in the reconstructed prompt sentence, the server directs the generative AI model to perform constrained generation. The generative AI model, when executing on this reconstructed prompt, reuses the structured fashion elements and the previous description to produce a revised description. As a result, the server avoids computing a completely new design from scratch and instead performs an incremental update. This leads to reduced inference time and fewer changes to the model's internal context, which improves stability of results and reduces unexpected variance. From a technical standpoint, the server improves computational efficiency and ensures that the generative AI model operates as a controllable module under well-defined constraints.

The server then updates the structured fashion elements according to the revised description by re-parsing the response text and modifying only the necessary fields, such as length and decorative elements. The server also stores the feedback information and the emotion information in association with the updated structured data. The server may record multiple versions of the design and their corresponding feedback, thereby building a user-specific interaction history.

In another embodiment, the server uses the accumulated structured data to adjust inference parameters of the generative AI model. For instance, the server may compute statistics on which fashion elements are repeatedly preferred by the user and encode such statistics into additional tokens or control vectors that are appended to subsequent prompt sentences. Alternatively, the server may adjust sampling temperature or probability truncation parameters of the generative AI model based on a measure of past satisfaction. These technical operations allow the server to balance exploration and exploitation in design generation, resulting in improved convergence to stable user-preferred design spaces and reduced number of iterations needed to achieve satisfaction.

The server also converts the fashion design description text and the fashion design image data into a format suitable for virtual fitting in a virtual space. In one embodiment, the server maps each fashion element and relevant geometric attributes (such as length and silhouette) to parameters of a garment representation on a three-dimensional avatar. The server may use a parametric garment model in which parameters correspond to lengths, widths, flare levels, and other geometric features. The server associates color and texture attributes with material maps used for rendering. The server packages these parameters and associated texture images into a structured representation that can be interpreted by a virtual fitting application.

The terminal or another information processing device executes the virtual fitting application. The virtual fitting application loads the garment parameters and textures provided by the server and applies them to a digital avatar whose body shape information corresponds to the user. The terminal displays, on the display device, a rendering of the avatar wearing the generated fashion design in a virtual environment. The user sees how the design would look when worn and can interact with the avatar, for example by rotating the view or changing poses.

The user then provides additional feedback based on the virtual fitting experience, such as: “The skirt looks too wide from the side view; make it slightly narrower.”

The terminal sends this additional feedback information to the server. The server again reconstructs prompt sentences incorporating both the original design, the updated design, and the virtual fitting feedback. As a concrete example, the server may generate:

“The current dress design for virtual fitting is: [current fashion design description text and geometric parameters].

The user feedback after virtual fitting is: ‘The skirt looks too wide from the side view; make it slightly narrower.’

Revise the silhouette parameters to narrow the skirt width while keeping the overall elegant evening style. Output an updated fashion design description and updated fashion elements suitable for regenerating both an image and virtual fitting parameters.”

The server then calls the generative AI model and the image-generation generative AI model with the reconstructed prompt sentence. The server applies the revised fashion elements to update both the image and the virtual fitting parameters. This feedback loop is not a simple automation of human design work; rather, it implements a new data-driven control flow within the server, where the generative AI model is constrained by and optimized with respect to a structured interaction history and specific technical performance goals such as reduced number of iterations and consistent geometry parameters for virtual rendering.

From a computer-technology perspective, the described system improves operation of the server and terminal in several ways. First, the explicit structuring of fashion elements enables the server to store and retrieve design-relevant attributes using indexed database queries, thereby reducing memory and processing overhead for each new design generation. Second, the explicit management of prompt sentences and reconstructed prompt sentences allows the server to reuse context, reducing the length of input and output sequences processed by the generative AI model. This leads to lower computational complexity because the number of tokens processed by the transformer layers is reduced or better organized, which directly reduces the number of attention computations and associated latency.

Third, the server's approach to integrating emotion information and feedback information into prompt sentences and inference conditions allows the server to adjust generative model behavior in a way that leads to faster convergence to user-desired designs, thus reducing the number of model invocations and the communication volume between the server and the terminal. Fourth, by transforming design descriptions into virtual fitting parameters in a structured form, the server enables reusability of parameterized garments across sessions and across different users with similar body shape profiles, which improves caching performance and reduces redundant graphics computations in the virtual fitting application.

In one alternative embodiment, the server executes a local generative AI model entirely within its own hardware, whereas in another embodiment, the server communicates with an external inference service that runs the generative AI model on separate hardware resources. In a further alternative embodiment, the server uses a smaller, distilled generative AI model for incremental updates after an initial design is created by a larger baseline model, thereby balancing accuracy and computation cost. In yet another embodiment, the server uses different generative AI models specializing in different garment categories, and selects a model based on the clothing type extracted as a fashion element. These variations still rely on the same core concept of structured fashion element extraction, prompt sentence management, and virtual fitting integration.

In yet another embodiment, the terminal may perform part of the processing, such as preliminary tokenization of user input or caching and reapplication of commonly used prompt fragments, to further reduce communication load and server processing. In another variation, multiple terminals may share a common server instance that maintains separate structured data for each user. The server may also implement load balancing and distributed storage for scalability, but continues to perform the design generation and updating operations as described.

By implementing the described hardware and software configuration, the server, the terminal, and the generative AI models cooperate to provide a computer-implemented fashion design system that goes beyond simple automation of human design tasks. The system structures data, controls model behavior through engineered prompt sentences, and integrates virtual fitting parameters to achieve technical effects such as reduced inference time, improved stability of design updates, efficient storage and retrieval of design history, and decreased network bandwidth usage. These improvements constitute enhancements to the functionality and efficiency of computer systems in the field of AI-based fashion design and virtual try-on.

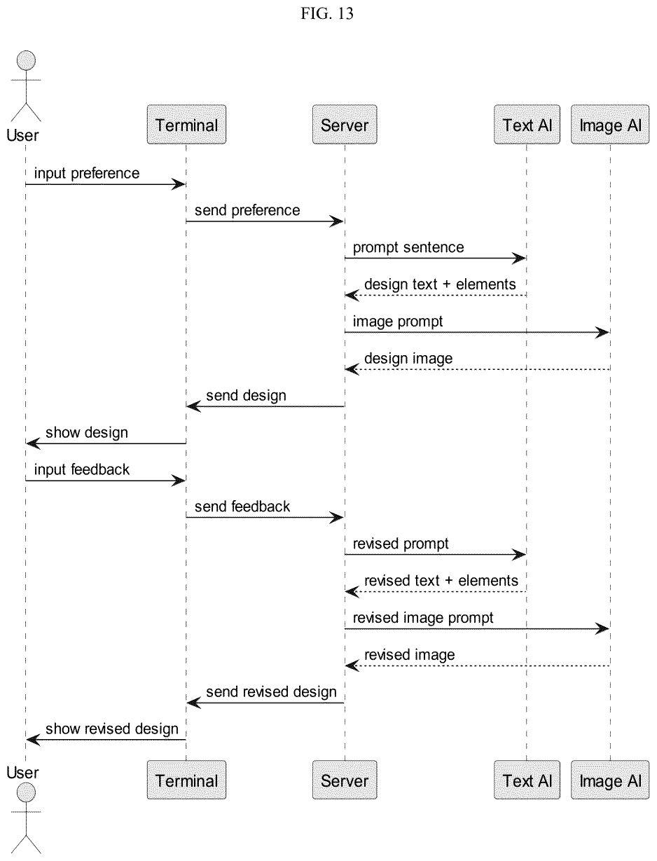

The following describes the processing flow using FIG. 13.
Step 1:

The user operates the terminal to input fashion preference text.

The terminal displays a text input field and a send button on a graphical user interface.

Input: a raw text string typed by the user, such as “a red silk dress with long sleeves for an evening party”.

The terminal validates that the text length is within a predetermined range and normalizes the character encoding to a unified encoding.

The terminal generates a request data structure including at least a user identifier and the normalized text string.

Output: a structured request message containing the user identifier and the preference text, ready to be transmitted to the server.
Step 2:

The terminal transmits the request message to the server.

Input: the structured request message generated in Step 1.

The terminal encapsulates the request message in a network protocol frame and sends it through a communication interface to a server endpoint.

The terminal sets headers including a content type and an authentication token.

Output: a network packet stream carrying the user's preference text and metadata toward the server.
Step 3:

The server receives and parses the request message.

Input: the network packet stream from the terminal.

The server reassembles packets into a complete request, verifies the authentication token, and checks the syntax of the message body.

The server extracts the user identifier and the preference text from the message and stores a log record into a storage device.

Output: an internal data object containing the user identifier, the raw preference text, and a request identifier.
Step 4:

The server constructs a first prompt sentence for a generative AI model.

Input: the raw preference text and a predefined prompt template stored in memory.

The server substitutes a placeholder in the template with the preference text and concatenates fixed instruction segments and variable segments.

For example, the server generates:

“Act as a professional fashion designer. The user prefers the following clothing: ‘a red silk dress with long sleeves for an evening party’.
1) Extract and list the fashion elements: color, material, clothing type, sleeve style, length, silhouette, decorative elements, and usage scene.
2) Based on these elements, write a detailed fashion design description that can later be used to generate an image.”

The server associates the constructed prompt sentence with the request identifier.

Output: a prompt sentence string ready to be provided to the generative AI model.
Step 5:

The server invokes the generative AI model to analyze the prompt sentence and generate a response.

Input: the prompt sentence string produced in Step 4.

The server tokenizes the prompt sentence using a tokenizer, converting characters into a sequence of token identifiers.

The server supplies the token identifiers to a transformer-based generative AI model running in inference mode.

The generative AI model performs multiple layers of attention and feedforward computation to transform input token embeddings into output token probabilities.

The server samples output tokens from the probability distributions according to configured sampling parameters to generate a response text.

Output: a response text including at least a list of fashion elements and a fashion design description.
Step 6:

The server parses the response text to extract structured fashion elements and a design description.

Input: the response text from the generative AI model.

The server scans the response text line by line and applies pattern-matching rules to detect labels such as “Color:”, “Material:”, “Clothing type:”, “Sleeve style:”, “Length:”, “Silhouette:”, “Decorative elements:”, and “Usage scene:”.

The server extracts the string following each label as a value and trims unnecessary punctuation.

The server also identifies a section of the response text designated as the fashion design description.

The server constructs a structured record containing the extracted element fields and the design description text.

Output: a structured fashion element object and a fashion design description text associated with the user and the request.
Step 7:

The server stores the structured fashion elements and the design description in a database.

Input: the structured fashion element object and the fashion design description text from Step 6.

The server generates a new design identifier and inserts a row into a design table with columns such as user identifier, design identifier, fashion element fields, design description, and timestamps.

The server commits the transaction to ensure persistence and indexability of the data.

Output: a persistent database record linking the user, the structured fashion elements, and the design description.
Step 8:

The server generates an image-generation prompt sentence for an image-generation generative AI model.

Input: the structured fashion elements and the fashion design description text.

The server selects key attributes such as color, material, clothing type, length, silhouette, decorative elements, and usage scene.

The server composes an image-oriented description, for example:

“High-resolution fashion illustration of an elegant knee-length red silk dress with long sleeves, fitted waist, slightly flared skirt, subtle lace details at the cuffs, V-neckline, suitable for an evening party, front view, neutral studio background.”

The server records the image-generation prompt sentence in association with the design identifier.

Output: an image-generation prompt sentence string for use by the image-generation generative AI model.
Step 9:

The server invokes the image-generation generative AI model to create fashion design image data.

Input: the image-generation prompt sentence from Step 8.

The server encodes the prompt sentence via a text encoder to obtain context embeddings.

The server initializes a latent image representation as random noise and iteratively applies a denoising network conditioned on the context embeddings according to a diffusion schedule. At each iteration, the server computes an updated latent representation that reduces noise while incorporating semantic constraints derived from the prompt sentence.

After completing the iterations, the server decodes the latent representation into an image matrix and converts the matrix into an image file.

Output: fashion design image data associated with the design identifier.
Step 10:

The server stores the fashion design image data and prepares a response to the terminal.

Input: the fashion design image data and the structured design record.

The server writes the image file to a storage device and obtains a location identifier such as a file path or a resource locator.

The server updates the database record to include the location of the image file.

The server constructs a response message including the fashion element fields, the design description text, and the image location.

Output: a response message containing all design information to be sent to the terminal.
Step 11:

The terminal receives and presents the fashion design to the user.

Input: the response message from the server.

The terminal parses the message and extracts the textual and image location components.

The terminal requests and loads the image file from the provided location and renders it on the display device.

The terminal displays the design description text alongside the image and may show individual fashion elements as labels.

Output: a visual and textual presentation of the generated fashion design to the user.
Step 12:

The user evaluates the presented fashion design and provides feedback.

Input: the displayed image and text on the terminal.

The user inspects the visual appearance and the description and decides on desired changes or an evaluation score.

The user enters feedback text, such as “Make the dress shorter and add lace around the neckline,” and optionally selects a rating.

Output: a feedback dataset including feedback text and optional evaluation values input into the terminal.
Step 13:

The terminal transmits the feedback dataset to the server.

Input: the feedback dataset created in Step 12 and the design identifier maintained locally.

The terminal bundles the feedback dataset and the design identifier into a feedback request message.

The terminal again uses the communication interface to send the feedback request to the server.

Output: a network packet stream containing feedback information directed to the server.
Step 14:

The server receives the feedback information and associates it with the existing design record.

Input: the feedback request message from the terminal.

The server parses the message, verifies the design identifier, and retrieves the corresponding design record from the database.

The server inserts a new feedback record including the design identifier, the feedback text, and an evaluation value.

The server may also link or store emotion information if available.

Output: an updated set of database records associating the design, the user, and the feedback.
Step 15:

The server reconstructs a new prompt sentence incorporating the feedback and optional emotion information.

Input: the existing fashion design description, the structured fashion elements, the feedback text, and any emotion information.

The server composes a revised instruction, for example:

“The current dress design is: [current design description].

The user feedback is: ‘Make the dress shorter and add lace around the neckline.’

Revise the design according to this feedback. Keep the main concept (red silk, long sleeves, elegant evening style), but adjust the length and neckline decoration. Output a new, complete fashion design description and updated fashion elements.”

The server embeds the previous design description and the feedback into a single textual sequence with explicit revision instructions.

Output: a reconstructed prompt sentence that encodes constraints and revision requirements for the generative AI model.
Step 16:

The server invokes the generative AI model again to generate an updated design.

Input: the reconstructed prompt sentence from Step 15.

The server tokenizes the reconstructed prompt sentence and feeds the token identifiers to the generative AI model.

The generative AI model processes the new sequence, taking into account the explicit revision instructions, and produces an updated response text.

The server parses the updated response text, extracts revised fashion elements, and obtains an updated design description.

Output: an updated structured fashion element object and an updated fashion design description.
Step 17:

The server updates the stored structured data and regenerates the fashion design image data.

Input: the updated structured fashion elements and updated design description from Step 16.

The server modifies the existing database record or creates a new version entry reflecting the revised elements.

The server composes a new image-generation prompt sentence based on the updated elements, such as reflecting a shorter length and added lace at the neckline.

The server invokes the image-generation generative AI model with the new image-generation prompt sentence to produce a revised image.

Output: revised fashion design image data and an updated design record stored in the database.
Step 18:

The terminal receives and displays the revised design to the user.

Input: a new response message from the server including the updated design description and the location of the revised image.

The terminal loads the revised image and replaces or supplements the display with the updated design.

The terminal shows the updated description and any changed fashion elements.

Output: a refreshed visual and textual representation of the revised fashion design for further user evaluation.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional fashion design and virtual try-on systems primarily treat generative models, recommendation engines, and virtual fitting functions as isolated components. As a result, such systems typically perform only a single, static generation of design data from a coarse user query, and then render that data as fixed images or models. They do not tightly integrate natural-language processing, emotion estimation, prompt-construction logic, generative artificial intelligence models, iterative feedback handling, and augmented-reality or virtual-reality rendering into a unified control flow operated by a processor.

Because of this loose coupling, several technical problems arise. First, the server often receives unstructured natural-language input and forwards it directly to a generative model without extracting structured attributes or emotion, leading to unstable and non-deterministic generation behavior, and requiring repeated manual trial-and-error prompts. This imposes unnecessary computational load on the generative model and increases network traffic between client and server, resulting in degraded system throughput and latency.

Second, conventional systems lack a defined mechanism to encode user feedback and emotional state into machine-interpretable update prompts. Feedback is usually applied only at the user interface layer (for example, simple sliders or color pickers) and is not coherently propagated back into the generative model. Consequently, the server cannot perform efficient, stateful, iterative refinement of design data; instead, the system frequently regenerates designs from scratch, consuming additional compute resources and causing redundant rendering and data transfer operations.

Third, existing virtual try-on pipelines frequently operate with generic three-dimensional assets that are not parametrically linked to the attributes output by the generative model. This separation inhibits automatic, fine-grained updates of 3D assets based on incremental changes in color, style, or geometry, and often requires manual re-authoring of assets or full reload of scenes. This in turn increases the processing burden on the terminal and leads to jitter, frame drops, and poor user experience when performing real-time augmented-reality or virtual-reality rendering.

Fourth, many systems ignore the temporal relationship between user emotion and generated designs. Generated designs are not stored in association with the user's emotional state and design attributes, making it impossible for the server to efficiently recall and reuse suitable historical designs when similar emotional or preference patterns recur. This lack of structured design history forces the generative model to recompute designs even when appropriate candidates already exist, thereby increasing processor utilization and energy consumption. Accordingly, there is a need for an improved computer-implemented system in which a processor (i) converts ambiguous natural-language prompt sentences into structured, model-oriented prompt sentences using explicit attribute extraction and emotion estimation, (ii) orchestrates iterative design adjustment by reconstructing update prompt sentences from feedback and emotion data, and (iii) programmatically links design data to three-dimensional assets for real-time virtual try-on, while (iv) maintaining a design history indexed by emotional state for efficient recall. Such a system would improve the functioning of the underlying computers by reducing redundant model calls, optimizing data flows between server, storage, and terminals, and stabilizing generative outputs through structured prompt control, thereby providing faster, more resource-efficient, and more consistent generative-design and virtual try-on operations.

The specific processing by the specific processing unit 290 of the data processing device 12 in Application Example 2 is realized by the following means.

The present invention provides a server comprising a processor and a storage device, the processor being configured to execute instructions that cause the server to acquire, via an information processing apparatus, request information including garment or outfit preferences and an emotional state by receiving a natural-language prompt sentence input by a user; to perform natural-language processing on the prompt sentence to extract attribute information including at least a color, a style, a category, a use scene, and an emotional expression, to estimate, by using an emotion analysis engine, the emotional state of the user, and to construct, on the basis of the attribute information and the emotional state, a model-oriented prompt sentence for input to a generative artificial intelligence model; to input the constructed prompt sentence to the generative artificial intelligence model so as to cause the generative artificial intelligence model to generate description data and image data of a fashion design, and to store the description data and the image data as design data in the storage device; to generate, on the basis of the design data, three-dimensional shape data for virtual try-on or display image data, and to transmit the three-dimensional shape data or the display image data to a portable information terminal or a visual display apparatus via a communication interface; to control, via instructions sent to the portable information terminal or the visual display apparatus, a virtual try-on display in a virtual store space according to a viewpoint and a body shape of the user by using the three-dimensional shape data or the display image data, and to acquire feedback information from the user regarding the virtual try-on display; to reconstruct, on the basis of the feedback information and the emotional state, an update prompt sentence for the generative artificial intelligence model; to input the update prompt sentence to the generative artificial intelligence model to iteratively adjust the fashion design; and to store, in the storage device, the emotional state and the fashion design in association with each other as a design history and, in a subsequent session, retrieve and present a portion of the design history corresponding to an estimated emotional state prior to execution of a new generation process by the generative artificial intelligence model. This enables the computer system to transform unstructured natural-language inputs and emotional signals into structured, generative-model-oriented prompt sentences that drive stable, resource-efficient design generation and iterative refinement, to maintain a reusable, emotion-indexed design history that reduces redundant generative processing, and to programmatically synchronize updated design parameters with three-dimensional assets for real-time augmented-reality or virtual-reality try-on, thereby improving overall computational performance, responsiveness, and consistency of the generative design and virtual try-on pipeline.

The term “processor” refers to a hardware or virtual computation unit, such as a central processing unit or a programmable logic device, configured to execute instructions stored in a memory to perform data processing, control, and communication operations of the system.

The term “storage device” refers to a non-transitory computer-readable medium, such as a semiconductor memory, magnetic storage, or optical storage, configured to store data including prompt sentences, attribute information, emotional states, design data, and design histories.

The term “information processing apparatus” refers to an electronic apparatus, such as a client device or a user terminal, that enables a user to input information, transmits the information to the server, and receives and displays data provided by the server.

The term “portable information terminal” refers to a handheld or wearable electronic device, such as a smartphone, a tablet, or a portable computing device, capable of wireless communication with the server and execution of an application for presenting design data and virtual try-on displays.

The term “visual display apparatus” refers to a display-capable device, such as a head-mounted display, smart glasses, or a monitor, configured to visually present images, three-dimensional graphics, or virtual reality scenes to a user.

The term “communication apparatus” refers to a hardware and software communication interface, such as a network interface controller and communication stack, configured to transmit and receive data between the server and external devices over a wired or wireless network.

The term “natural-language prompt sentence” refers to a sequence of words expressed in a human language, input by a user, that describes preferences, requirements, or conditions for generating a fashion design.

The term “request information” refers to data derived from a natural-language prompt sentence, including at least user preferences for garments or outfits and, optionally, an emotional state, that is used as an input for subsequent processing.

The term “attribute information” refers to structured data elements extracted from a natural-language prompt sentence, including at least a color, a style, a category, a use scene, and an emotional expression relevant to fashion design generation.

The term “color” refers to a property of a fashion item representation indicating a hue, saturation, and brightness or a discrete color label used in the design.

The term “style” refers to one or more categorical descriptors of the appearance or impression of a fashion item, such as casual, formal, sporty, or elegant.

The term “category” refers to a classification label indicating a type of garment or outfit, such as dress, jacket, shirt, pants, or outfit set.

The term “use scene” refers to contextual information indicating an intended occasion or environment for wearing a garment, such as everyday wear, party, formal event, or sports activity.

The term “emotional expression” refers to textual content within a natural-language prompt sentence that directly or indirectly indicates a user's emotional state or mood.

The term “emotional state” refers to a representation of a user's mood or affect, expressed or inferred from input data, such as relaxed, energetic, calm, excited, or similar labels, optionally accompanied by a confidence score.

The term “emotion analysis engine” refers to a software component or model configured to analyze input data, such as text or signals, and to estimate an emotional state of a user.

The term “generative artificial intelligence model” refers to a machine-implemented model, such as a neural network, configured to generate new data samples, including at least textual descriptions or images of fashion designs, in response to an input prompt.

The term “model-oriented prompt sentence” refers to a text instruction constructed from attribute information and an emotional state, formatted in a manner suitable for input to a generative artificial intelligence model to control its output.

The term “description data” refers to structured or unstructured textual data output by the generative artificial intelligence model that describes characteristics of a fashion design, including attributes such as style, color, and structure.

The term “image data” refers to digital image information, such as raster image data or encoded image files, generated by or based on outputs of the generative artificial intelligence model and representing a visual depiction of a fashion design.

The term “design data” refers to data stored in the storage device that includes at least description data and image data for a fashion design, and optionally additional metadata such as parameters and identifiers.

The term “three-dimensional shape data” refers to digital geometric data, such as meshes, vertices, edges, and surfaces, representing the three-dimensional form of a garment or outfit suitable for virtual try-on rendering.

The term “display image data” refers to digital image data, including two-dimensional rendered images or textures, prepared for direct display on a screen or for use as part of a three-dimensional rendering process.

The term “virtual try-on display” refers to a visual presentation in which a garment or outfit, represented by three-dimensional shape data or display image data, is displayed as if worn by a user or an avatar, enabling the user to visually assess fit and appearance.

The term “virtual store space” refers to a computer-generated three-dimensional or two-dimensional environment that simulates a store or showroom in which garments or outfits are displayed and may be virtually tried on.

The term “viewpoint” refers to a position and orientation in a virtual or augmented-reality scene from which the system renders a visual image for display to a user.

The term “body shape” refers to information representing a user's physical dimensions or proportions, such as height, width, or body contour parameters, used to adapt three-dimensional shape data for virtual try-on.

The term “feedback information” refers to data input by a user after viewing a design or virtual try-on display, including at least preferences or modification requests relating to color, style, shape, or other design aspects.

The term “update prompt sentence” refers to a model-oriented prompt sentence reconstructed on the basis of feedback information and an emotional state, used to request an adjusted design from the generative artificial intelligence model.

The term “iteratively adjust” refers to repeatedly updating a fashion design by generating successive versions through repeated interaction between the server and the generative artificial intelligence model using updated prompt sentences.

The term “design history” refers to a set of records stored in the storage device, each record associating a fashion design with at least an emotional state and related attributes, for later retrieval and reuse.

The term “subsequent session” refers to a later interaction period between a user and the system that occurs after a previous session in which design data and emotional states were stored.

The term “candidate fashion designs” refers to one or more fashion designs selected from design history and presented to the user as potential options before invoking a new generation process by the generative artificial intelligence model.

The term “display control function for augmented reality” refers to processing operations that combine real-world sensor data with virtual content to overlay three-dimensional shape data on a view of a physical environment in real time.

The term “display control function for virtual reality” refers to processing operations that render a fully virtual environment and three-dimensional content for display to a user, typically through a head-mounted display or similar device.

The term “position-and-posture information” refers to data describing a user's spatial location and orientation, such as translation and rotation, obtained from sensors for the purpose of aligning three-dimensional content.

The term “body characteristic information” refers to data describing physical attributes of a user's body, including size measurements, limb lengths, or posture characteristics, used for scaling and fitting garments in a virtual try-on display.

The term “color parameter” refers to a data value or set of values within design data or three-dimensional shape data that determine the color or color scheme applied to a garment representation.

The term “style parameter” refers to a data value or set of values controlling stylistic aspects of a garment representation, such as silhouette, looseness, decorative elements, or pattern style.

The term “shape parameter” refers to a data value or set of values that define or modify geometric aspects of a garment representation, such as length, width, curvature, or volume.

The term “alignment and scaling” refers to computational operations that position and size three-dimensional shape data relative to a user's body or avatar so that the virtual garment visually matches the user's body position, posture, and size.

The term “communication interface” refers to a logical and physical interface implemented by hardware and software that enables the server to send and receive data over a communication network.

In one embodiment, a server, one or more terminals, and one or more users cooperate to implement the claimed system. The server includes at least one processor, a main memory, a non-transitory storage device, and a communication interface connected to a communication network. The terminal includes a processor, a memory, a communication interface, one or more sensors such as a camera and an inertial sensor, and a display unit such as a touch screen or a head-mounted display. The user operates the terminal to input information and to view and interact with generated fashion designs.

The server executes a server-side program that is stored in the storage device and loaded into the main memory. The server-side program is implemented, for example, in a high-level programming language executed on an operating system running on a general-purpose computing platform. The server-side program is logically divided into functional modules, including at least a natural-language processing module, an emotion analysis module, a prompt construction module, a generative AI interface module, a design data management module, and a virtual try-on preparation module.

The terminal executes a client-side program, such as a mobile application running on a smartphone, tablet, or wearable computing device, or a browser-based application running in a web browser. The client-side program includes at least a user interface module, a communication module, a rendering module, and a sensor control module. In one embodiment, the rendering module is implemented using a graphics engine such as a three-dimensional rendering engine, and the sensor control module acquires position-and-posture information and body characteristic information from the camera and inertial sensors.

The user operates the terminal to input a natural-language prompt sentence describing preferences for garments or outfits and optionally describing an emotional state. The user may type, for example, “I feel relaxed today and I want a casual, comfortable outfit in blue,” “Design a blue casual jacket,” “Design a red silk dress with an elegant style for a summer party,” “Today I feel energetic; please design bright sporty casual wear,” or “I want a casual summer dress in pastel colors.” The terminal displays a text input field and passes the entered character string, encoded for example in UTF-8, together with a session identifier and a user identifier, to the communication module.

The terminal uses the communication module to send the natural-language prompt sentence to the server over the network using a predefined application-layer protocol such as HTTPS. The terminal can also attach sensor-derived metadata, such as an approximate body height or body type, for use in later virtual try-on preparation. The communication interface of the server receives the HTTP request and passes the request data to the server-side program.

The server uses the natural-language processing module to parse the received prompt sentence. In one embodiment, the server uses a trained language model implemented with a neural network library such as a general deep learning framework. The language model is, for example, a transformer-based encoder that maps tokenized text into contextual embeddings. The server applies tokenization to the prompt sentence, maps tokens to vectors, and feeds the token sequence into the language model. The language model outputs a sequence of hidden states that the server further processes to extract attribute information using classification and sequence labeling heads. These heads may consist of fully connected layers followed by a softmax function that output probabilities over predefined label sets, such as color labels, style labels, category labels, and use scene labels.

The server stores intermediate results in an internal data structure, for example a structured object that includes fields for color, style, category, use scene, and any detected emotional expression segments. The server can map open-vocabulary phrases to normalized labels using a lookup table and similarity scoring in an embedding space. This specific data structure enables the server to represent the attributes of the fashion design request in a normalized, machine-interpretable form, which in turn improves the stability and reproducibility of subsequent generative AI outputs compared to direct free-text prompting.

The server uses the emotion analysis module to estimate an emotional state of the user. In one embodiment, the server uses a text-based emotion classifier implemented as a neural network model that receives the prompt sentence (or extracted emotional expression segments) and outputs a distribution over emotion categories such as relaxed, energetic, calm, excited, or neutral. The model may include an encoder, such as a bidirectional recurrent network or transformer encoder, followed by a classification layer. The server applies a loss function such as cross-entropy during training so that the classifier learns to associate text patterns with emotion labels, and updates model parameters using gradient-based optimization such as stochastic gradient descent or adaptive gradient methods. During inference, the server selects the emotion label with the highest probability, optionally applying a threshold on the confidence score. The server writes the resulting emotional state into a record associated with the current session.

The server uses the prompt construction module to construct a model-oriented prompt sentence for the generative AI model. This module receives the normalized attribute information and the emotional state and assembles them into a structured textual instruction. For example, the server may construct a text such as “User mood: relaxed. Preferred color: blue. Preferred style: casual, comfortable. Category: outfit. Please generate a detailed fashion design description and an image for this outfit.” By explicitly encoding each attribute and mood label, the server ensures that the generative AI model receives a consistent, structured input that reduces variance in output and decreases the need for repeated trial-and-error prompts. The server can apply a rule-based template system that selects sentence fragments based on which attributes are present, avoiding ambiguous phrasing and thereby improving generative stability.

The server uses the generative AI interface module to communicate with a generative AI model. The generative AI model may be deployed on the same hardware as the server or on a separate computation node accessible over the network. The generative AI model is, for example, a large-scale neural network model trained to generate textual descriptions and images of fashion designs based on a received prompt. In one embodiment, the generative AI model includes a text-to-text component (such as a transformer-based language model) that generates a detailed description of a garment, and a text-to-image component (such as a diffusion-based generative model) that produces an image of the garment.

The text-to-text component receives the model-oriented prompt sentence and produces a sequence of output tokens representing a description. The transformer architecture includes an embedding layer, multiple self-attention layers, feed-forward layers, and normalization layers. During training, the model minimizes a token prediction loss over a large corpus of prompt-description pairs. The text-to-image component receives either the same prompt or the generated description and produces an image by iteratively refining noise into a coherent image according to a diffusion process or an equivalent generative procedure, while conditioning on the embedded text representation. The server sends the prompt sentence to the generative AI model, receives the description data and image data, and stores them as design data in the storage device.

The server uses the design data management module to assign identifiers to each design and to record metadata including the associated emotion, attributes, and session information. The server stores the design data in a structured database, for example a relational or document-oriented database. Images may be stored as files in a file system or object store, and references to those files are stored as part of the design data record. By associating design data with emotional state and attributes, the server can later retrieve suitable designs without re-running the generative AI model, thereby reducing computational load and improving system response time.

The server uses the virtual try-on preparation module to convert the design data into three-dimensional shape data or display image data. In one embodiment, the server maps high-level design attributes to parametric three-dimensional garment templates. The server maintains a library of base garment meshes (e.g., for jackets, dresses, shirts, pants) and a set of parameterized deformation functions that modify length, width, sleeve shape, neckline, and other geometric features. The server applies a mapping rule that sets these parameters based on the design description and attributes. The server then computes a modified mesh by applying the parameterized deformation functions, and assigns material properties such as base color, texture, and reflectance according to the attributes and the generated image. The server encodes the resulting three-dimensional shape data, for example, as a mesh file in a standard three-dimensional format, and transmits it, together with associated textures, to the terminal.

The terminal uses the rendering module to load the received three-dimensional shape data and display image data. In an augmented-reality embodiment, the terminal uses an augmented-reality framework to detect the user's body or an approximate skeleton in real time using the camera and motion sensors. The terminal computes position-and-posture information and applies alignment and scaling operations to overlay the three-dimensional garment mesh onto the user's body or avatar. The terminal continuously updates the rendering as sensor measurements change and as the user moves. This processing is executed on the terminal's graphics processor, thereby controlling physical display hardware to produce a synchronized virtual try-on display that reacts to real-world movements of the user. The user views the virtual try-on display and provides feedback. The user may type text such as “Make the sleeves shorter and use brighter blue,” “Make the skirt longer and more elegant,” or “Use more vivid colors.” The terminal collects the feedback information and sends it to the server in association with the current design identifier. The server then uses the prompt construction module again, this time integrating the original design description, the feedback information, and the emotional state to reconstruct an update prompt sentence. For example, the server may construct “Current design: loose-fit blue linen shirt with mid-length sleeves and casual joggers. User feedback: make the sleeves shorter and use a brighter shade of blue. User mood: relaxed. Generate an updated design description and image incorporating these changes while keeping the casual, comfortable style.”

The server provides the update prompt sentence to the generative AI model. Internally, the generative AI model processes the update prompt as a new input, but the presence of explicit references to the previous design and the requested modifications enables the model to perform targeted adjustments in its latent representation space rather than regenerate an entirely unrelated design. In a diffusion-based image generator, the model may initialize the diffusion process using a latent representation corresponding to the previous image and then condition the denoising steps on the updated text embeddings. This approach reduces the number of inference steps and improves consistency between design versions, which in turn reduces bandwidth usage because only delta texture or delta geometry information may need to be transferred in some configurations.

The terminal updates the displayed design based on the updated three-dimensional shape data or display image data. The terminal may re-use previously downloaded geometry and apply local parameter adjustments (e.g., reducing sleeve length or changing color parameters in a shader) instead of downloading an entirely new model, thereby reducing communication load between the server and the terminal. This design of data structures and parameterized geometry contributes to improved communication efficiency and rendering responsiveness compared to conventional systems that transmit complete models for every change.

The server stores both the original design and each updated design as part of a design history. The server associates each design record with an emotional state and attribute information and writes the records into the storage device. When the user later starts a new session and inputs a prompt sentence containing a similar emotional expression, such as “I feel relaxed today,” the server uses the stored design history to identify prior designs linked to the same emotional state and similar attributes. The server retrieves a subset of candidate fashion designs and sends them to the terminal as initial options, optionally together with an explanation, before invoking the generative AI model. This process reduces the number of generative model calls, decreases average latency, and improves computational efficiency by reusing previously computed results.

The described configuration produces a technical effect beyond merely automating a human designer's work. The server transforms ambiguous natural-language prompt sentences into structured attribute information and emotion labels using specific neural network architectures and data structures; constructs standardized model-oriented prompt sentences using rule-based templates; controls a generative AI model through these structured prompts to obtain stable, high-quality design data; and links the design data to three-dimensional mesh parameters in a way that allows efficient, incremental updates of rendered content. These operations improve processing speed by reducing unnecessary generative computations, improve precision and consistency of generated designs through normalized attribute extraction and structured prompting, improve data management through an emotion-indexed design history, and reduce communication load through re-use of parameterized geometries and partial updates.

The server, in implementing the natural-language processing and emotion analysis modules, uses training procedures that further enhance technical performance. During model training, the server defines feature vectors for tokens and sentences, applies data augmentation such as synonym replacement or paraphrasing to increase robustness, and uses regularization techniques such as dropout to prevent overfitting. The server also defines explicit evaluation metrics such as attribute extraction accuracy, emotion classification accuracy, and generative prompt stability, and adjusts model hyperparameters to optimize these metrics. This training regime produces models that operate reliably on noisy user input text, which again leads to more efficient use of generative AI resources and more accurate mapping between user intention and system behavior.

The terminal, by using real-time tracking and rendering hardware acceleration, provides a virtual try-on display that is tightly synchronized with the user's physical motions. The integration of three-dimensional shape data, sensor data, and rendering algorithms enables the system to control display devices in a way that could not be achieved by manual methods. The alignment and scaling of meshes based on body characteristic information corrects for distortions and ensures that garments appear in the correct size and position, which is a technical improvement in the accuracy and realism of augmented-reality rendering.

In alternative embodiments, the server may use different types of neural network architectures for the natural-language processing and generative components, such as convolutional neural networks, recurrent networks, or hybrid models, and may use different loss functions or optimization algorithms. The server may also adapt the size and composition of the attribute label sets and emotion categories to different application domains. The terminal may be realized as a desktop computer, a game console, or another computing device equipped with a display and sensors. The communication interface may use different network protocols, including wired or wireless standards. In each case, the server still performs the characteristic transformations of user input into structured prompt sentences, execution of generative AI models under those prompts, management of emotion-indexed design histories, and coordination with the terminal for virtual try-on rendering.

By combining these hardware and software elements in the described way, the system improves the functioning of the underlying computers and networks. The system reduces redundant computation and data transfer through structured prompting and design history reuse, stabilizes generative AI behavior through explicit attribute and emotion encoding, and enhances rendering performance through parametric three-dimensional models and real-time sensor-based alignment. These technical improvements distinguish the system from conventional arrangements that merely automate business or design tasks without altering the operation of the computing infrastructure itself.

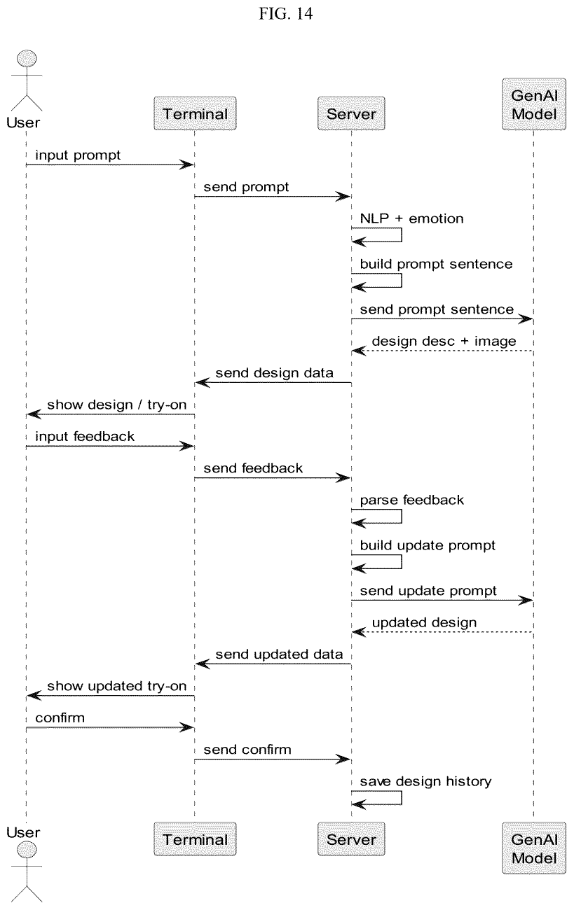

The following describes the processing flow using FIG. 14.
Step 1:

User operates the terminal to start an application and to input a natural-language prompt sentence describing fashion preferences and optionally an emotional state.

User provides, as input, a text string such as “I feel relaxed today and I want a casual, comfortable outfit in blue,” “Design a blue casual jacket,” or “Design a red silk dress with an elegant style for a summer party.”

Terminal receives the input text, encodes it (for example in UTF-8), attaches a session identifier and user identifier, and forms a request object.

Terminal outputs a structured request containing the prompt sentence and identifiers and sends this request to the server via a secure network connection.
Step 2:

Server receives, as input, the request object including the prompt sentence and identifiers from the terminal.

Server validates the session identifier, checks basic formatting of the text, and stores the raw prompt sentence in a temporary record in a database.

Server outputs the stored record and passes the prompt sentence to a natural-language processing module as a character sequence for further analysis.
Step 3:

Server uses the natural-language processing module to parse, as input, the prompt sentence and to extract attribute information.

Server tokenizes the text into tokens, maps tokens to vector embeddings using a language model, and applies classification and sequence-labeling layers to compute probabilities for labels such as color, style, category, and use scene.

Server performs data processing by selecting, for each attribute type, the label or labels with highest probability and normalizing them using a predefined mapping table.

Server outputs a structured attribute object containing fields such as color (e.g., “blue”), style (e.g., “casual,” “comfortable”), category (e.g., “outfit,” “jacket,” “dress”), and use scene (e.g., “summer party”).
Step 4:

Server receives, as input, the original prompt sentence and any extracted emotional expression text.

Server applies an emotion analysis module that encodes the text with a neural encoder and computes an emotion probability distribution over predefined emotion labels.

Server performs data computation by applying a softmax function to the logits, choosing the label with maximum probability, and optionally checking a confidence threshold.

Server outputs an emotional state label such as “relaxed” or “energetic,” together with a confidence score, and stores this emotional state in association with the session and user.
Step 5:

Server receives, as input, the structured attribute object and the emotional state label.

Server constructs a model-oriented prompt sentence by combining these elements with template sentences in a deterministic, rule-based manner.

Server performs string assembly operations, inserting normalized attribute values and the emotion label into predefined template slots, and ensures that all required attributes are explicitly named.

Server outputs a constructed prompt sentence such as “User mood: relaxed. Preferred color: blue. Preferred style: casual, comfortable. Category: outfit. Please generate a detailed fashion design description and an image for this outfit.”
Step 6:

Server provides, as input, the constructed model-oriented prompt sentence to a generative AI model through a generative AI interface module.

Server sends the text to a text-to-text component to generate a detailed design description and, optionally, sends the same or derived text to a text-to-image component to generate an image.

Server receives, as output from the text-to-text component, a sequence of tokens forming description data, and receives, as output from the text-to-image component, image data representing the fashion design.

Server performs data storage operations by writing the description data, image data, and associated metadata into a design record in the storage device and outputs a design identifier for later reference.
Step 7:

Server receives, as input, the design record containing description data, image data, and attributes.

Server uses a virtual try-on preparation module to map the design attributes and description to three-dimensional garment parameters by applying rule sets that associate design features with mesh deformation parameters.

Server performs data computation by adjusting a base mesh geometry (for example, sleeve length, garment length, and width) and assigning material parameters (for example, base color and texture coordinates) according to the design record.

Server outputs three-dimensional shape data and related display image data, packages them with the design identifier, and transmits them to the terminal via the communication interface.
Step 8:

Terminal receives, as input, the three-dimensional shape data, display image data, and design identifier from the server.

Terminal stores the data temporarily in local memory and loads the three-dimensional shape data into a rendering engine.

Terminal performs data processing by converting the mesh and texture data into internal graphics buffers and by preparing shader parameters that encode color and material properties.

Terminal outputs a rendered view of the fashion design on the display, showing either a static image or an initial three-dimensional representation.
Step 9:

User operates the terminal to enable a virtual try-on mode.

Terminal receives, as input, sensor data from a camera and inertial sensors and detects a user body or avatar pose using a tracking algorithm.

Terminal performs data computation by estimating a skeleton or body shape, computing position-and-posture information, and calculating a scale factor that relates the three-dimensional garment mesh to the user's dimensions.

Terminal outputs a virtual try-on display by rendering the aligned and scaled three-dimensional shape data over a live camera image or within a virtual store environment, and presents this display to the user on the screen or head-mounted display.
Step 10:

User observes the virtual try-on display and inputs, as feedback, a new natural-language text describing desired changes.

User may type, for example, “Make the sleeves shorter and use brighter blue,” “Make the skirt longer and more elegant,” or “Use more vivid colors.”

Terminal receives the feedback text and associates it with the current design identifier and session identifier.

Terminal outputs a feedback request object containing the feedback text and identifiers and transmits it to the server via the communication module.
Step 11:

Server receives, as input, the feedback request object containing the feedback text, the design identifier, and the session identifier.

Server retrieves the original design record and its description and attributes from the storage device by using the design identifier.

Server applies natural-language processing to the feedback text to identify requested modifications such as color changes, length adjustments, or style changes, by using similar tokenization, embedding, and classification techniques as in earlier steps.

Server performs data processing by merging the original attributes and the extracted modification directives into an update specification object, and outputs this object together with the emotional state label for prompt reconstruction.
Step 12:

Server receives, as input, the update specification object, the original description data, and the emotional state label.

Server uses the prompt construction module to build an update prompt sentence that explicitly states the current design and requested changes.

Server performs string concatenation and templating operations to generate text such as “Current design: loose-fit blue linen shirt with mid-length sleeves and casual joggers. User feedback: make the sleeves shorter and use a brighter shade of blue. User mood: relaxed. Generate an updated design description and image incorporating these changes while keeping the casual, comfortable style.”

Server outputs this update prompt sentence and passes it to the generative AI model through the generative AI interface module.
Step 13:

Server provides, as input, the update prompt sentence to the generative AI model for refinement.

Server receives, as output, new description data and new image data that represent an adjusted fashion design aligned with the feedback and emotional state.

Server performs comparison operations between previous and new design attributes to identify changed parameters, and updates the design record by adding a new version with its own identifier while preserving a link to the previous version for history tracking.

Server outputs updated design data, including any changed color parameters, length parameters, or geometry parameters, and sends either full updated three-dimensional shape data or parameter deltas to the terminal.
Step 14:

Terminal receives, as input, the updated design data from the server.

Terminal determines whether complete geometry or only parameter deltas have been provided and, if deltas are provided, applies these changes to the existing three-dimensional mesh by adjusting shader parameters and mesh deformation parameters.

Terminal performs rendering computations to update the virtual try-on display in real time, re-aligning the garment mesh to the current body pose while applying the changed visual attributes.

Terminal outputs a refreshed virtual try-on display reflecting the updated design and presents it to the user without requiring a full reload of the scene.
Step 15:

Server receives, as input, final confirmation from the terminal that the user is satisfied with the current design, together with the emotional state and associated attributes.

Server performs data storage operations by writing a design history record that associates the final design identifier, emotional state, attribute information, and optionally user measurements into the storage device.

Server indexes this record under keys that include at least the emotional state and selected attributes, enabling efficient retrieval during future sessions through database queries and similarity matching.

Server outputs an updated design history structure that can be used as input in later sessions to propose candidate fashion designs without executing a full generative AI model run for similar emotional states and attribute combinations.
Step 16:

Server receives, as input in a later session, a new prompt sentence that includes an emotional expression similar to one stored in the design history, such as “I feel relaxed today.”

Server queries the storage device using the emotional state label and optionally other attributes extracted from the new prompt sentence to find one or more matching design history records.

Server performs ranking or selection computations based on similarity measures and recency and selects a subset of candidate fashion designs as reuse candidates.

Server outputs these candidate fashion designs to the terminal as initial options, thereby reducing the need for a new generative AI model call and improving response time and resource efficiency.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

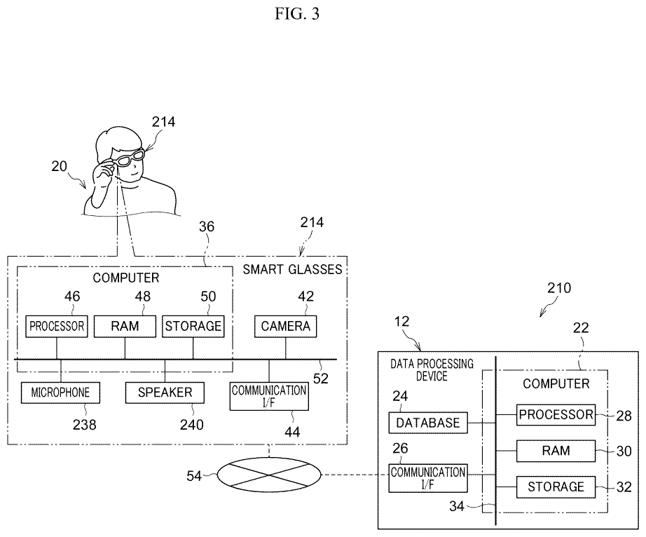

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

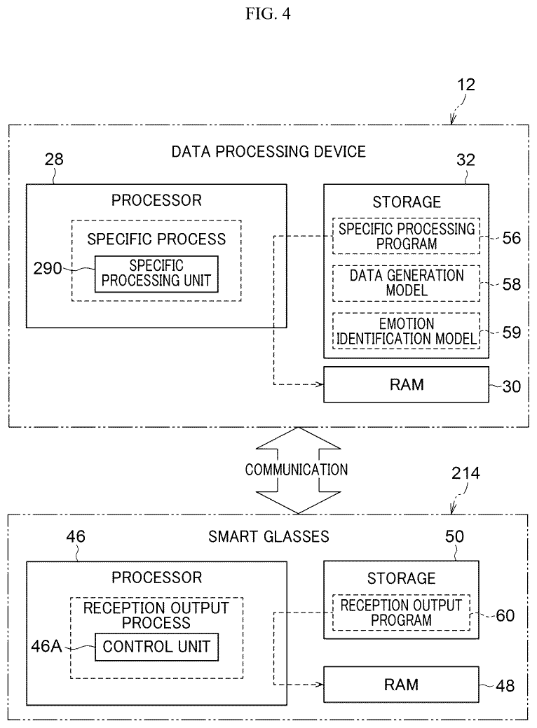

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

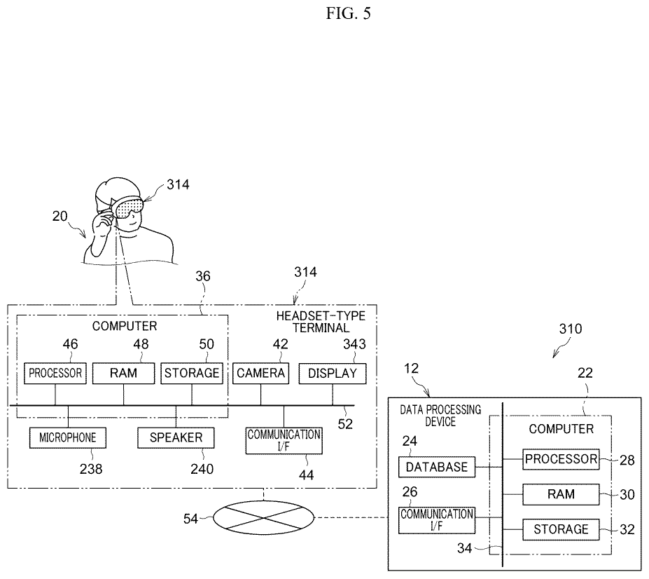

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

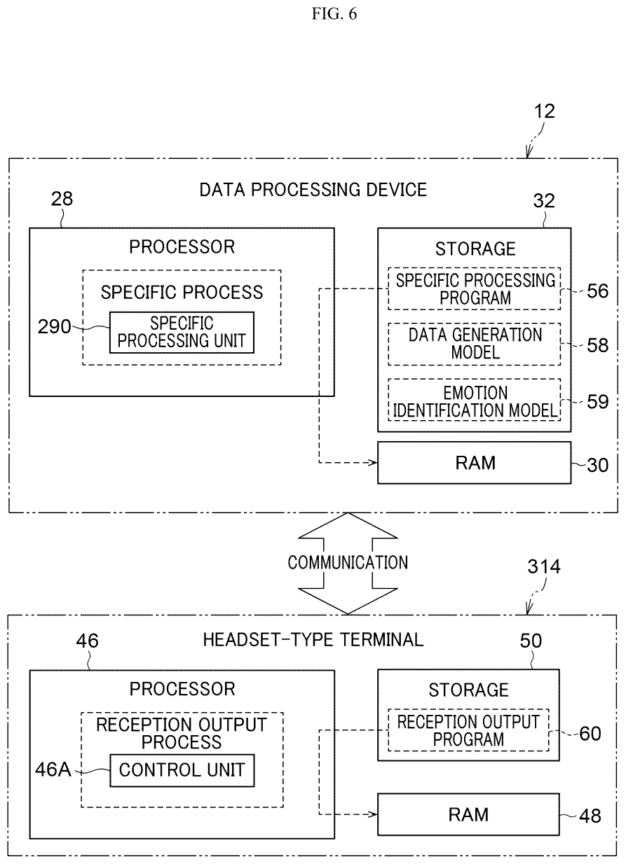

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

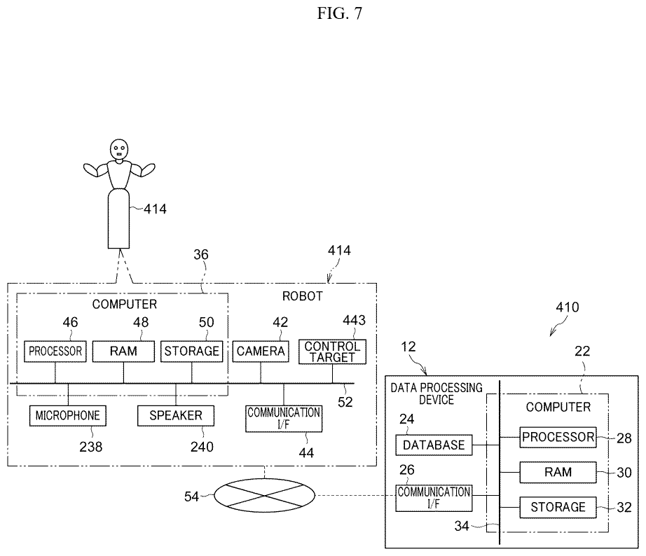

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

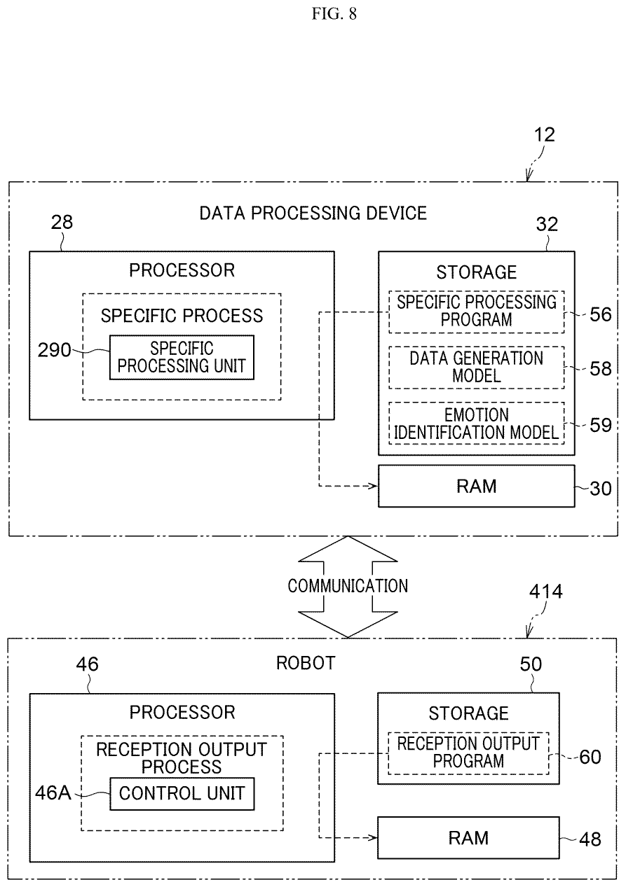

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

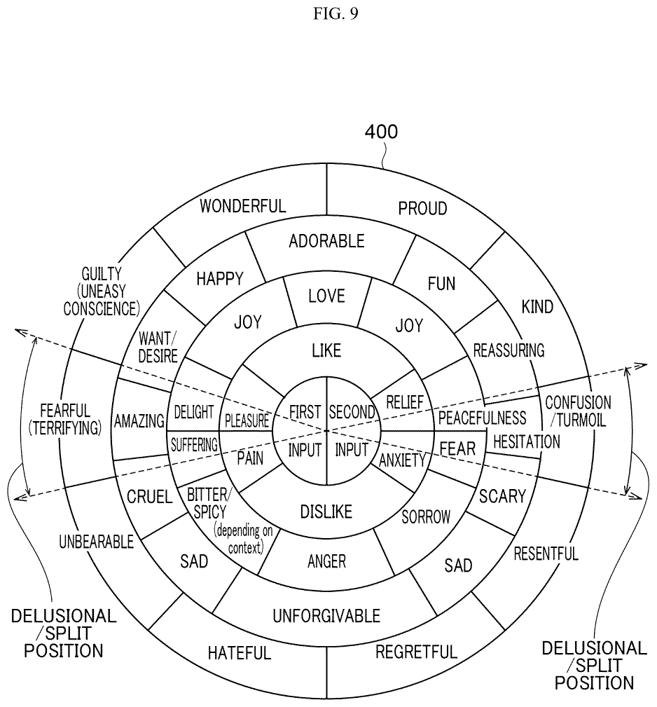

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

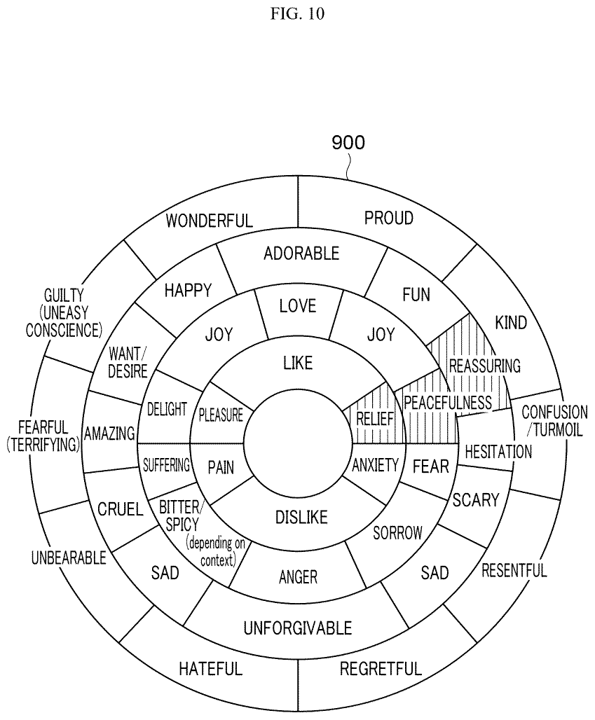

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
cause a terminal to provide an information input interface that allows a user to input a natural-language description of preferred clothing or styles, and to transmit the natural-language description from the terminal to a server,
receive, at the server, the natural-language description transmitted from the terminal, analyze the natural-language description by using a natural-language processing algorithm to extract keywords indicating attributes including at least a color, a material, a shape, and a style, and convert the extracted keywords into normalized attribute information based on a higher-level attribute schema,
generate a prompt sentence for a generative AI model by embedding the normalized attribute information into a prompt template configured for input to the generative AI model,
transmit the generated prompt sentence to the generative AI model and cause the generative AI model to generate proposal information for clothing or styles that matches the user's preference based on the prompt sentence,
receive, from the generative AI model, the proposal information and convert the proposal information into display data, and transmit the display data to the terminal so that the proposal information is presented to the user,
cause the terminal to provide an interface that allows the user to input feedback in natural language with respect to the proposal information, and to transmit the feedback from the terminal to the server,
receive, at the server, the feedback, analyze the feedback by using the natural-language processing algorithm to extract keywords indicating a design change request, update the normalized attribute information based on the design change request, reconstruct the prompt sentence based on the updated attribute information, and retransmit the reconstructed prompt sentence to the generative AI model so as to cause the generative AI model to iteratively generate updated proposal information for clothing or styles reflecting the user's feedback, and
estimate an emotional state of the user by using an emotion estimation algorithm, and adjust at least one of the prompt sentence and the normalized attribute information in accordance with the estimated emotional state so that proposal information reflecting the emotional state of the user is generated by the generative AI model.

### Supplementary 2

The system according to supplementary 1,
wherein the processor is configured to store, in a storage device, as a data set associated with an identifier, at least the proposal information for clothing or styles generated by the generative AI model based on the user's preference and the emotional state, the natural-language description, the prompt sentence, the feedback, and the normalized attribute information, and to reuse the stored data set for generation of a subsequent prompt sentence or proposal information.

### Supplementary 3

The system according to supplementary 1,
wherein the processor is configured to present the proposal information for clothing or styles generated by the generative AI model on a display device of the terminal, to gradually adjust a design through the iterative processing of updating the prompt sentence in response to the user's feedback, and to provide, as an application on the terminal, a virtual try-on function that superimposes the clothing or styles on body information of the user by using at least one of virtual-reality technology and augmented-reality technology.

### Application Example 1

### Supplementary 1

A system comprising a processor,
wherein the processor is configured to
cause a terminal device to display guidance information that prompts a user to input natural language description information regarding preferences for garments or accessories, and to acquire the description information from the user,
communicate with the terminal device so as to receive the description information, and analyze the description information to convert the description information into structured data by extracting attribute information including at least one of shape, color, material, decoration, use scene, silhouette, and size feeling,
generate a prompt sentence including the attribute information on the basis of the structured data, transmit the prompt sentence as input to a generative AI model, and obtain response information from the generative AI model, the response information including design information regarding an individual fashion design,
generate three-dimensional shape data for a garment and surface material data on the basis of the design information, the three-dimensional shape data and the surface material data being associable with skeletal information and body-shape information of a virtual human model, and generate virtual try-on visual data by aligning and deforming the three-dimensional shape data with respect to the virtual human model,
transmit the virtual try-on visual data to the terminal device and enable the terminal device to display the fashion design from a 360-degree direction in accordance with viewpoint movement that orbits around the virtual human model,
acquire, via the terminal device, additional natural language description information or correction instruction information from the user, associate the additional natural language description information or the correction instruction information with the description information, update the prompt sentence for the generative AI model, and iteratively update the design information and the virtual try-on visual data, and
acquire information indicating an emotional state of the user and adjust the fashion design by changing contents of the design information on the basis of both the emotional state and the attribute information.

### Supplementary 2

The system according to supplementary 1,
wherein the processor is configured to store the structured data, the prompt sentence, the design information, and the virtual try-on visual data in a storage device in association with user identification information and the information indicating the emotional state of the user, and to regenerate a fashion design in accordance with a preference tendency and an emotional tendency of the user by using information stored in the storage device.

### Supplementary 3

The system according to supplementary 1,
wherein the processor is configured to cause an application program operating on the terminal device to present the virtual try-on visual data, summary information of the fashion design, and candidate design information based on the design information, to acquire evaluation information or feedback information from the user, and to reflect the evaluation information or the feedback information in the structured data and the prompt sentence so as to control generation processing by the generative AI model.

### Example 2

### Supplementary 1

A system comprising a processor,
wherein the processor is configured to
receive, from a user via an information processing terminal, a natural language input sentence including information about the user's preferred clothing and style, and transmit the natural language input sentence from the information processing terminal to an information processing server via a communication unit,
cause the information processing server to receive the natural language input sentence, generate a prompt sentence including the natural language input sentence, and cooperate with a generative artificial intelligence model to perform analysis and generation processing on text data by parsing the prompt sentence to extract fashion elements including at least a color, a material, a clothing type, a silhouette, a decorative element, and a usage scene, and by generating, based on the fashion elements, an individualized fashion design description text, cause the information processing server to generate, based on the fashion design description text, an image-generation prompt sentence, and to cooperate with an image-generation generative artificial intelligence model using the image-generation prompt sentence as input to generate fashion design image data,
cause the information processing server to store the fashion elements, the fashion design description text, and the fashion design image data as structured data in a storage device, and to transmit the structured data to the information processing terminal,
cause the information processing terminal to present the fashion design description text and the fashion design image data on a display device, acquire feedback information from the user including at least a design change request or an evaluation, and transmit the feedback information to the information processing server,
cause the information processing server to reconstruct at least one of the prompt sentence and the image-generation prompt sentence based on the feedback information, and to iteratively update the fashion design description text and the fashion design image data by cooperating with the generative artificial intelligence model and the image-generation generative artificial intelligence model, and
recognize an emotion of the user and adjust the fashion design description text and the fashion design image data by reflecting emotion information corresponding to the emotion in at least one of the prompt sentence and the image-generation prompt sentence.

### Supplementary 2

The system according to supplementary 1,
wherein the processor is configured to cause the information processing server to store, for each user, the fashion elements, the fashion design description text, the fashion design image data, the feedback information, and the emotion information in association with one another in a database, and to use the associated data for generation of a subsequent prompt sentence and for setting inference conditions of the generative artificial intelligence model.

### Supplementary 3

The system according to supplementary 1,
wherein the processor is configured to cause the information processing server to convert the fashion design description text and the fashion design image data into a format applicable to body shape information of the user in a virtual space, provide the converted data to a virtual fitting application operating on at least one of the information processing terminal and another information processing device, present a virtual fitting experience of the fashion design to the user through the virtual fitting application, and acquire additional feedback information regarding the virtual fitting experience and transmit the additional feedback information to the information processing server.

### Application Example 2

### Supplementary 1

A system comprising a processor,
wherein the processor is configured to
acquire, via an information processing apparatus, request information including preferences for garments or outfits and an emotional state, by receiving a natural-language prompt sentence input by a user, and
perform natural-language processing on the prompt sentence to extract attribute information including at least a color, a style, a category, a use scene, and an emotional expression, estimate the emotional state of the user by using an emotion analysis engine, and construct, on the basis of the attribute information and the emotional state, a prompt sentence for input to a generative artificial intelligence model, and
input the constructed prompt sentence to the generative artificial intelligence model to cause the generative artificial intelligence model to generate description data and image data of a fashion design, and store the description data and the image data as design data in a storage device, and
generate, on the basis of the design data, three-dimensional shape data for virtual try-on or display image data, and transmit the three-dimensional shape data or the display image data to a portable information terminal or a visual display apparatus via a communication apparatus, and
control the portable information terminal or the visual display apparatus to perform a virtual try-on display in a virtual store space according to a viewpoint and a body shape of the user by using the three-dimensional shape data or the display image data, and acquire feedback information from the user regarding the virtual try-on display, and
reconstruct, on the basis of the feedback information and the emotional state, an update prompt sentence for the generative artificial intelligence model, and input the update prompt sentence to the generative artificial intelligence model to iteratively adjust the fashion design.

### Supplementary 2

The system according to supplementary 1,
wherein the processor is configured to store, in the storage device, the emotional state and the fashion design in association with each other as a design history, and, in a subsequent session, to retrieve and present a design history corresponding to an estimated emotional state, thereby presenting candidate fashion designs prior to execution of a new generation process by the generative artificial intelligence model.

### Supplementary 3

The system according to supplementary 1,
wherein the processor is configured to cause the portable information terminal or the visual display apparatus, in the virtual try-on display, to use a display control function for augmented reality or virtual reality to perform, in real time, alignment and scaling of the three-dimensional shape data on the basis of position-and-posture information and body characteristic information of the user, and, in response to the feedback information, to redisplay updated three-dimensional shape data or updated display image data in which at least one of a color parameter, a style parameter, and a shape parameter has been changed.

What is claimed is:

1. A system comprising:
circuitry configured to:
receive, via a communication interface coupled to a packet-switched network, a natural language description of user preferences from a terminal device, and store the natural language description in a storage device;
analyze the natural language description using a natural language processing algorithm to extract attribute information including at least a color, a material, a style, and a silhouette, and generate a prompt sentence for a generative AI model based on the extracted attribute information; and
cause the generative AI model to generate a design output based on the prompt sentence, recognize an emotional state of the user based on data received from the terminal device via the communication interface, adjust the design output based on the recognized emotional state, and transmit the adjusted design output to the terminal device via the communication interface.

2. The system according to claim 1, wherein the circuitry is configured to
generate the prompt sentence to instruct the generative AI model to describe a preferred style of the user and to generate an individual design based on preferences of the user indicated in the natural language description.

3. The system according to claim 2, wherein the circuitry is configured to
cooperate with the generative AI model to iteratively refine the design output based on additional natural language input received from the terminal device via the communication interface.

4. The system according to claim 1, wherein the circuitry is configured to
store the generated design output in a database in the storage device in association with user attribute information and the recognized emotional state, and retrieve the stored design output for subsequent personalization.

5. The system according to claim 4, wherein the circuitry is configured to
present the generated design output to the user via the terminal device, receive user feedback on the presented design output, and incorporate the feedback into a subsequent prompt sentence for the generative AI model.

6. The system according to claim 1, wherein the circuitry is configured to
generate a visual representation of the design output using an image generation model, and transmit the visual representation to the terminal device for display.

7. The system according to claim 6, wherein the circuitry is configured to
generate a virtual fitting visualization by applying the visual representation to a body model generated from body measurement data received from the terminal device via the communication interface.

8. The system according to claim 1, wherein the circuitry is configured to
recognize the emotional state of the user by applying an emotion analysis engine to at least one of text input, vocal characteristics, and facial expression data received from the terminal device.

9. The system according to claim 8, wherein the circuitry is configured to
adjust at least one of a color scheme, a style category, and a material attribute of the design output based on the recognized emotional state of the user.

10. The system according to claim 1, wherein the circuitry is configured to
receive body measurement data from the terminal device via the communication interface, and incorporate the body measurement data into the prompt sentence to generate a design output customized to the body type of the user.

11. The system according to claim 10, wherein the circuitry is configured to
generate a size specification and a construction detail for the design output based on the body measurement data and the extracted attribute information, and store the size specification and the construction detail in the storage device.

12. The system according to claim 1, wherein the circuitry is configured to
receive, from the terminal device, trend data representing current market trends, incorporate the trend data into the prompt sentence for the generative AI model, and generate a design output reflecting both user preferences and current trends.

13. The system according to claim 12, wherein the circuitry is configured to
score the generated design output based on a consistency metric comparing the design output with the extracted attribute information and the trend data, and filter design outputs having a consistency score below a predetermined threshold.

14. The system according to claim 1, wherein the circuitry is configured to
generate a plurality of design output variations in response to a single natural language description, and present the variations to the terminal device ranked by a relevance score computed from the extracted attribute information.

15. The system according to claim 14, wherein the circuitry is configured to
receive a selection of one of the design output variations from the terminal device, store the selected variation in the storage device, and use the selected variation to update a user preference model.

16. The system according to claim 1, wherein the circuitry is configured to
generate manufacturing data for the design output in a digital format, and transmit the manufacturing data to a fabrication interface via the communication interface to enable production of a physical item.

17. The system according to claim 16, wherein the circuitry is configured to
validate the manufacturing data against a set of production constraints stored in the storage device prior to transmitting the manufacturing data to the fabrication interface.

18. A system comprising:
circuitry configured to:
receive, via a communication interface coupled to a packet-switched network, a natural language description of user preferences from a terminal device and store it in a storage device;
analyze the natural language description using a natural language processing algorithm to extract attribute information, generate a prompt sentence incorporating the extracted attribute information and body measurement data, and input the prompt sentence to a generative AI model to generate a design output;
recognize an emotional state of the user based on data received from the terminal device via the communication interface, and adjust the design output based on the recognized emotional state; and
transmit the adjusted design output to the terminal device via the communication interface, store the design output in the storage device, and refine subsequent design outputs based on user feedback.

19. The system according to claim 18, wherein the circuitry is configured to
generate a visual representation of the design output using an image generation model, apply the visual representation to a body model derived from body measurement data, and transmit a virtual fitting visualization to the terminal device.

20. A method comprising:
receiving, via a communication interface coupled to a packet-switched network, a natural language description of user preferences from a terminal device and storing the natural language description in a storage device;
analyzing the natural language description using a natural language processing algorithm to extract attribute information, and generating a prompt sentence for a generative AI model based on the extracted attribute information; and
causing the generative AI model to generate a design output based on the prompt sentence, recognizing an emotional state of the user based on data received from the terminal device via the communication interface, adjusting the design output based on the recognized emotional state, and transmitting the adjusted design output to the terminal device via the communication interface.
